(19) United States
(12) Patent Application Publication
(10) Pub. No.: US 2025/0174201 A1
(43) Pub. Date: May 29, 2025

(54) GATE DRIVER AND DISPLAY DEVICE INCLUDING THE SAME

(71) Applicant: LG Display Co., Ltd., Seoul (KR)

(72) Inventors: Ki Tae KWON, Paju-si (KR); Jong Wook JANG, Paju-si (KR)

(73) Assignee: LG Display Co., Ltd., Seoul (KR)

(21) Appl. No.: 18/953,867

(22) Filed: Nov. 20, 2024

(30) Foreign Application Priority Data
Nov. 29, 2023 (KR) 10-2023-0169001
Sep. 6, 2024 (KR) 10-2024-0121448

(51) Int. Cl. G09G 3/3266; G09G 3/3258

(52) U.S. Cl. CPC G09G 3/3266; G09G 3/3258; G09G 2300/0408; G09G 2300/0819; G09G 2310/0286; G09G 2310/06; G09G 2320/0276; G09G 2354/00

(57) ABSTRACT

A gate driver and a display device including the same are discussed. The gate driver can include a plurality of signal transmission parts that are connected in a cascade manner via carry lines through which carry signals are applied from preceding signal transmission parts and are configured to output gate signals according to a clock signal. An (n)th signal transmission part (n being a positive integer) can include a first output circuit configured to receive a start pulse or an (n-1)th carry signal from a preceding signal transmission part and the clock signal, and charge or discharge a first-first control node and a first-second control node to output an (n)th carry signal, and a second output circuit configured to receive the (n)th carry signal output from the first output circuit and the clock signal, and charge or discharge a second-first control node and a second-second control node to output an (n)th gate signal.

### CROSS-REFERENCE TO RELATED APPLICATION

This application claims priority to Korean Patent Application No. 10-2023-0169001, filed on Nov. 29, 2023 in the Republic of Korea, and Korean Patent Application No. 10-2024-0121448, filed on Sep. 6, 2024 in the Republic of Korea, the entire contents of all these applications being hereby expressly incorporated by reference into the present application.

### BACKGROUND

### Field

The present disclosure relates to a gate driver and a display device including the same.

### Discussion of the Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In the organic light-emitting display devices, OLEDs are formed in each of pixels. These organic light display devices not only respond quickly and have excellent light-emitting efficiency, luminance, and viewing angle, but also have excellent contrast ratio and color reproduction rate because they can express black tones as complete black.

Users can play two or more content images on a single screen of a display device or execute two or more applications to play different images the applications on the screen. In such a multi-tasking environment, pixels on the display device are driven at a single frame frequency.

A gate driver of a display device is configured by incorporating a plurality of signal transmission parts, wherein gate signals are sequentially output from the plurality of signal transmission parts. If the output of a gate signal from a corresponding transmission part is blocked in the gate driver in order to skip a frame, then the output of gate signals from subsequent transmission parts is rendered to be blocked, making it impossible or difficult to output the gate signals again. For example, it is possible to drive at different frequencies for the respective display areas in a display panel in the direction of decreasing the frequencies, but it is not possible to drive at different frequencies for the respective display areas in the direction of increasing the frequencies.

### SUMMARY OF THE DISCLOSURE

The present disclosure is directed to solving or addressing the above-described necessity and limitations.

The present disclosure provides a gate driver capable of driving at multiple frequencies and a display device including the same.

It should be noted that objects of the present disclosure are not limited to the above-described objects, and other objects of the present disclosure will be apparent to those skilled in the art from the following descriptions.

A gate driver according to embodiments of the present disclosure can include a plurality of signal transmission parts that are connected in cascade via carry lines through which carry signals are applied from preceding signal transmission parts and are configured to output gate signals according to a clock signal, wherein an (n)th (n is a positive integer) signal transmission part includes a first output circuit configured to receive a start pulse or an (n-1)th carry signal from a preceding signal transmission part and the clock signal, and to charge or discharge a first-first control node and a first-second control node to output an (n)th carry signal and a second output circuit configured to receive the (n)th carry signal output from the first output circuit and the clock signal, and to charge or discharge a second-first control node and a second-second control node to output an (n)th gate signal.

A display device according to embodiments of the present disclosure can include a pixel array in which a number of data lines, a number of gate lines, and a number of pixel circuits are arranged, a data driver configured to output a data voltage to the number of data lines, and a gate driver configured to output a gate signal to the number of gate lines, wherein the gate driver includes a plurality of signal transmission parts that are connected in cascade via carry lines through which carry signals is applied from preceding signal transmission parts and that are configured to output gate signals according to a clock signal, and wherein an (n)th (n is a positive integer) signal transmission part includes a first output circuit configured to receive a start pulse or an (n-1)th carry signal from a preceding signal transmission part and the clock signal, and to charge or discharge a first-first control node and a first-second control node to output an (n)th carry signal; and a second output circuit configured to receive the (n)th carry signal output from the first output circuit and the clock signal, and to charge or discharge a second-first control node and a second-second control node to output an (n)th gate signal.

According to aspects of the present disclosure, each signal transmission part constituting the gate driver consists of two output circuits, one output circuit outputting a carry signal and the other outputting a gate signal, so that the carry signal is output to a subsequent signal transmission part regardless of whether the gate signal is output or not. As a result, the output of the gate signal to the respective display areas can be freely blocked, and thus the respective display areas can be driven at different frequencies.

According to aspects of the present disclosure, it is possible to easily change the positions of dividing the display areas to be driven at different frequencies by freely adjusting the period intended for blocking the output of the gate signal.

According to aspects of the present disclosure, a position at which a frequency is changed can be freely adjusted according to a working environment of a user, thereby reducing power consumption and enabling low-power driving.

The effects of examples of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIGS. 2 and 3 are diagrams to describe the principle of driving at different frequencies;

FIG. 4 is a diagram showing a pixel circuit according to a first embodiment of the present disclosure;

FIG. 5 is a diagram illustrating driving timings of the pixel circuit shown in FIG. 4;

FIG. 6 is a diagram showing a shift register in a gate driver according to a comparative example;

FIG. 7 is a diagram illustrating driving waveforms of the gate driver shown in FIG. 6;

FIG. 8 is a diagram showing a shift register in a gate driver according to an embodiment of the present disclosure;

FIG. 9 is a diagram illustrating driving waveforms of the gate driver shown in FIG. 8;

FIG. 10 is a diagram showing a gate driver that applies a gate signal to the pixel circuit shown in FIG. 4;

FIG. 11 is a diagram showing a gate driver according to the first embodiment;

FIG. 12 is a diagram illustrating driving waveforms during normal driving of the gate driver shown in FIG. 11;

FIGS. 13A to 13D are diagrams for describing an operating principle of the gate driver by way of the driving waveforms shown in FIG. 12;

FIG. 14 is a diagram illustrating driving waveform during a frame skipping in the gate driver shown in FIG. 11;

FIGS. 15A to 15D are diagrams illustrating an operating principle of the gate driver by way of the driving waveforms shown in FIG. 14;

FIG. 16 is a diagram showing a pixel circuit according to a second embodiment of the present disclosure;

FIG. 17 is a diagram illustrating driving timings of the pixel circuit shown in FIG. 16;

FIG. 18 is a diagram showing a gate driver that applies a gate signal to the pixel circuit shown in FIG. 16;

FIG. 19 is a diagram illustrating a gate driver according to the second embodiment;

FIG. 20 is a diagram illustrating driving waveforms during normal driving in the gate driver shown in FIG. 19;

FIGS. 21A to 21D are diagrams illustrating an operating principle of the gate driver by way of the driving waveforms shown in FIG. 20;

FIG. 22 is a diagram illustrating driving waveform during a frame skip in the gate driver shown in FIG. 19;

FIGS. 23A to 23D are diagrams illustrating an operating principle of the gate driver by way of the driving waveforms shown in FIG. 22;

FIG. 24 is a diagram showing a pixel circuit according to a third embodiment of the present disclosure;

FIG. 25 is a diagram illustrating driving timings of the pixel circuit shown in FIG. 24;

FIG. 26 is a diagram showing a gate driver that applies a gate signal to the pixel circuit shown in FIG. 24;

FIG. 27 is a diagram showing a shift register in a gate driver according to an embodiment of the present disclosure;

FIG. 28 is a diagram illustrating driving waveforms of the gate driver shown in FIG. 27;

FIG. 29 is a diagram illustrating a gate driver according to the third embodiment;

FIG. 30 is a diagram illustrating driving waveforms during a normal driving in the gate driver shown in FIG. 29;

FIGS. 31A to 31G are diagrams illustrating an operating principle of the gate driver by way of the driving waveforms shown in FIG. 30;

FIG. 32 is a diagram illustrating driving waveform during a frame skipping in the gate driver shown in FIG. 29;

FIGS. 33A to 33G are diagrams illustrating an operating principle of the gate driver by way of the driving waveforms shown in FIG. 32; and

FIGS. 34A to 34D are diagrams for describing a principle of modulation of clock signal.

### DETAILED DESCRIPTION OF THE EMBODIMENTS

Advantages and features of the present disclosure and methods of achieving them will become apparent with reference to preferable embodiments, which are described in detail, in conjunction with the accompanying drawings. However, the present disclosure is not limited to the embodiments to be described below and can be implemented in different forms, the embodiments are only provided to completely disclose the present disclosure and completely convey the scope of the present disclosure to those skilled in the art, and the present disclosure is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the disclosure. Further, in describing the present disclosure, when it is determined that a detailed description of related known technology can unnecessarily obscure the gist of the present disclosure, the detailed description thereof will be omitted.

When ‘including,’ ‘having,’ ‘consisting,’ and the like mentioned in the present disclosure are used, other parts can be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts can be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below can also be a second component within the technical spirit of the present disclosure.

The same reference numerals can refer to substantially the same elements throughout the present disclosure. Further, the term “can” fully encompasses all the meanings and coverages of the term “may.”

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings. All the components of each device and each apparatus according to all embodiments of the present disclosure are operatively coupled and configured.

In the embodiments of the present disclosure, a frame skip is implemented by blocking the output of the gate signal so that the respective display areas can be driven at different frequencies using the frame skip, wherein the period for blocking the gate signal is freely adjustable for the division of areas.

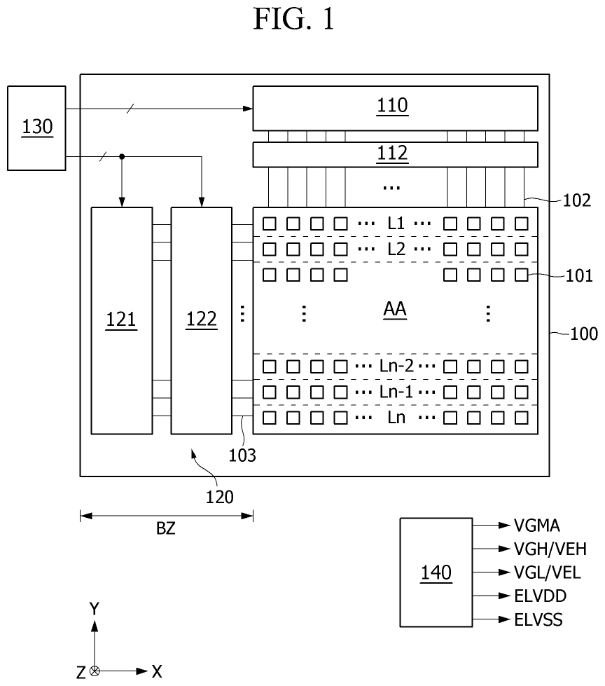

FIG. 1 is a block diagram illustrating a display device according to an embodiment of the present disclosure.

Referring to FIG. 1, a display device according to an embodiment of the present disclosure includes a display panel 100, a display panel driving unit configured to write pixel data to pixels of the display panel 100, and a power supply unit 140 configured to generate power required for driving the pixels and the display panel driving unit.

The display panel 100 includes a pixel array AA (or active area) that displays an input image. The pixel array AA includes a plurality of data lines 102, a plurality of gate lines 103 intersected with the data lines 102, and pixels arranged in a matrix form.

The pixel array AA includes a plurality of pixel lines L1 to Ln, where n is a real number such as a positive integer. Each of the pixel lines L1 to Ln includes one line of pixels arranged along a line direction X in the pixel array AA of the display panel 100. Pixels arranged in one pixel line share the gate lines 103. Sub-pixels arranged in a column direction Y along a data line direction share the same data line 102. One horizontal period 1H is a time obtained by dividing one frame period by the total number of pixel lines L1 to Ln.

Touch sensors can be disposed on the display panel 100. A touch input can be sensed using separate touch sensors or can be sensed through pixels. The touch sensors can be disposed as an on-cell type or an add-on type on the screen of the display panel or implemented as in-cell type touch sensors embedded in the pixel array AA.

The display panel 100 can be implemented as a flexible display panel. The flexible display panel can be made of a plastic OLED panel. An organic thin film can be disposed on a back plate of the plastic OLED panel, and the pixel array AA can be formed on the organic thin film.

The back plate of the plastic OLED can be a polyethylene terephthalate (PET) substrate. The organic thin film is formed on the back plate. The pixel array AA and a touch sensor array can be formed on the organic thin film. The back plate blocks moisture permeation so that the pixel array AA is not exposed to humidity. The organic thin film can be a thin Polyimide (PI) film substrate. A multi-layered buffer film can be formed of an insulating material on the organic thin film. Lines can be formed on the organic thin film so as to supply power or signals applied to the pixel array AA and the touch sensor array.

To implement color, each of the pixels can be divided into a red sub-pixel (hereinafter referred to as “R sub-pixel”), a green sub-pixel (hereinafter referred to as “G sub-pixel”), and a blue sub-pixel (hereinafter referred to as “B sub-pixel”). Each of the pixels can further include a white sub-pixel. Each of the sub-pixels 101 includes a pixel circuit. The pixel circuit is connected to the data line 102 and the gate line 103.

The power supply unit 140 generates direct current (DC) power necessary to drive the display panel driving unit and the pixel array of the display panel 100 by using a DC-DC converter. The DC-DC converter can include a charge pump, a regulator, a buck converter, a boost converter, and the like. The power supply unit 600 can adjust a level of an input DC voltage applied from a host system to generate constant voltages (or DC voltages) such as a gamma reference voltage VGMA, gate-on voltages VGH and VEH, gate-off voltages VGL and VEL, the pixel driving voltage ELVDD, and the low-potential power voltage ELVSS. The gamma reference voltage VGMA is supplied to a data driver 110. The gate-on voltages VGH and VEH and the gate-off voltages VGL and VEL are supplied to a gate driver 120. The pixel driving voltage ELVDD and the low-potential power voltage ELVSS are commonly supplied to the pixels.

The display panel driving unit writes an analog voltage corresponding to pixel data of an input image to the pixels of the display panel 100 under control of a timing controller (TCON) 130.

The display panel driving unit includes the data drivers 110 and the gate drivers 130.

A de-multiplexer (DEMUX) 112 can be disposed between the data driver 110 and the data lines 102. The de-multiplexer 112 sequentially connects one channel of the data driver 110 to the plurality of data lines 102 and distributes in a time division manner the data voltage outputted from one channel of the data driver 110 to the data lines 102, thereby reducing the number of channels of the data driver 110. The de-multiplexer 112 can be omitted. In this case, the output buffers of the data driver 110 are directly connected to the data lines 102.

The display panel driving unit can further include a touch sensor driver for driving the touch sensors. The touch sensor driver is omitted from FIG. 1. In a mobile device, the timing controller 130, the power supply 140, the data driver 110, and the like can be integrated into one drive integrated circuit (IC).

The data driver 110 generates a data voltage Vdata by converting pixel data of an input image received from the timing controller 130 with a gamma compensation voltage every frame period by using a digital to analog converter (DAC). The gamma reference voltage VGMA is divided for respective gray scales through a voltage divider circuit. The gamma compensation voltage divided from the gamma reference voltage VGMA is provided to the DAC of the data driver 110. The data voltage Vdata is outputted through the output buffer in each of the channels of the data driver 110.

The gate driver 120 can be implemented as a gate in panel (GIP) circuit formed directly on a bezel BZ area of the display panel 100 together with the TFT array of the pixel array AA. The gate driver 120 sequentially outputs gate signals to the gate lines 103 under the control of the timing controller 130. The gate driver 120 can sequentially supply the gate signals to the gate lines 103 by shifting the gate signals using a shift register.

The gate signal can include a scan signal for selecting pixels of a line in which data is to be written in synchronization with the data voltage and an EM signal defining a light-emitting time of pixels charged with the data voltage.

The gate driver 120 can include a scan driver 121, and an EM driver 122.

The scan driver 121 outputs a scan signal SCAN in response to a start pulse and a shift clock output from the timing controller 130, and shifts the scan signal SCAN in sync with a shift clock timing. The EM driver 122 outputs an EM signal EM in response to the start pulse and the shift clock output from the timing controller 130, and sequentially shifts the EM signal EM according to the shift clock. Accordingly, the scan signal SCAN, and the EM signal EM are sequentially supplied to the gate lines 103 of the pixel lines L1 to Ln. In the case of bezel-less models, at least some of the transistors constituting the gate driver 120 and clock wirings can be distributed and disposed in the pixel array AA.

The timing controller 130 receives digital video data DATA of an input image and a timing signal synchronized with the digital video data DATA from a host system. The timing signal can include a vertical synchronization signal Vsync, a horizontal synchronization signal Hsync, a main clock CLK, a data enable signal DE, and the like. The vertical synchronization signal Vsync and the horizontal synchronization signal Hsync can be omitted since a vertical period and a horizontal period can be obtained by a method of counting the data enable signal DE. The data enable signal DE has a period of one horizontal period 1H.

The host system can be one of a television system, a set-top box, a navigation system, a personal computer (PC), a home theater system, a vehicle system, and a system of a mobile device.

The timing controller 130 can multiply an input frame frequency by i and control an operation timing of the display panel driving circuit with a frame frequency of the input frame frequency×i Hz (here “i” is a positive integer greater than 0). The input frame frequency is 60 Hz in the National Television Standards Committee (NTSC) scheme and 50 Hz in the Phase-Alternating Line (PAL) scheme.

The timing controller 130 can generate a data timing control signal for controlling the operation timing of the data driver 110, MUX signals for controlling the operation timing of the de-multiplexer 112, and a gate timing control signal for controlling the operation timing of the gate driver 120 on the basis of the timing signals Vsync, Hsync, and DE received from the host system.

A voltage level of the gate timing control signal output from the timing controller 130 can be converted into the gate-on voltages VGH and VEH and the gate-off voltages VGL and VEL through a level shifter and supplied to the gate driving unit 120. For example, the level shifter converts a low-level voltage of the gate timing control signal into gate-low voltages VGL and VEL and converts a high-level voltage of the gate timing control signal into gate-high voltages VGH and VEH. The gate timing control signal includes the start pulse and the shift clock.

The timing controller 130 according to an embodiment can control the operation of the data driver 110 using a data timing control signal, and can control the operation of the gate driver 120 using a gate timing control signal. For example, the timing controller 130 can control the data driver 110 not to output a data voltage during the frame skip period, and it can control the gate driver 120 not to output a gate signal, in other words, it can control so that the gate signal output from the gate driver 120 becomes a gate-off voltage.

In the embodiment of the present disclosure, a plurality of areas are driven at different frequencies by using a frame skip, wherein positions for dividing the plurality of areas can also be changed. Here, the plurality of areas can include different pixel arrays.

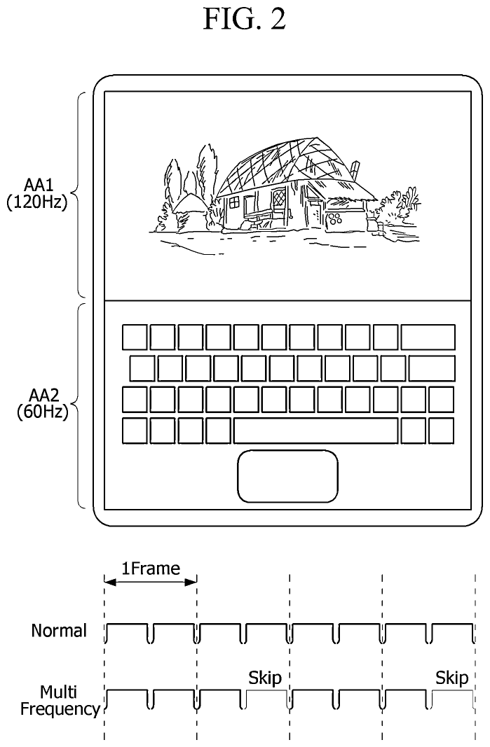

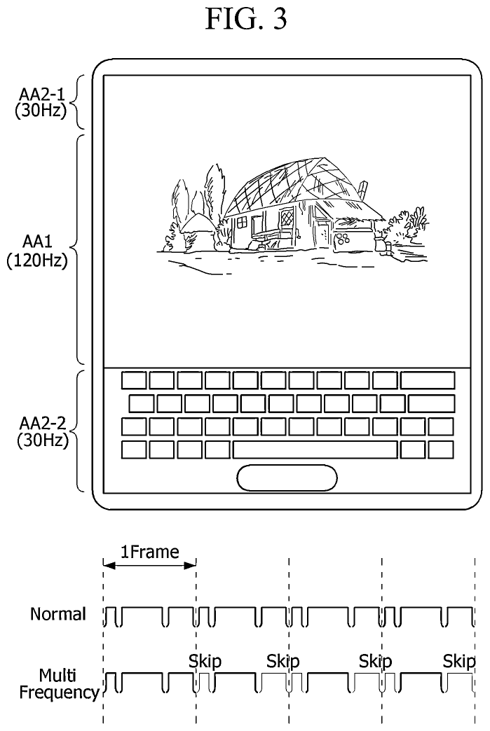

FIGS. 2 and 3 are diagrams to describe the principle of driving at different frequencies.

Referring to FIG. 2, in the embodiment, the screen can be divided into two areas, a first area AA1 and a second area AA2, wherein the first area AA1 can be driven at a frequency of 120 Hz, and the second area AA2 can be driven at a frequency of 60 Hz.

In a normal driving mode, image data is applied to the entirety of both the areas AA1 and AA2 during one frame period. In a multi-driving mode in which the screen is divided into the first area AA1 and the second area AA2, first image data DATA1 is applied to the first area AA1 and second image data DATA2 is applied to the second area AA2 during one frame period. For example, the first image data DATA1 can be moving image data, and the second image data DATA2 can be still image data.

In this case, no image data can be applied to the second area AA2 during a frame skip period according to the driving frequency.

For example, in the case where the first area is driven at a frequency of 120 Hz and the second area is driven at a frequency of 60 Hz, the first image data is applied to the first area AA1 in every frame period, and the second image data is not applied to the second area AA2 in one frame period out of every four frame periods.

In this case, since the first area AA1 and the second area AA2 are divided into the same size, the periods during which the first image data and the second image data are applied are made the same for each frame period.

Referring to FIG. 3, in an embodiment, the screen can be divided into three areas, a first area AA1, a second-first area AA2-1, and a second-second area AA2-2, wherein the first area AA1 is driven at a frequency of 120 Hz, and the second-first area AA2-1 and the second-second area AA2-2 are driven at a frequency of 30 Hz.

For example, in the case where the first area AA1 is driven at a frequency of 120 Hz and the second-first area AA2-1 and the second-second area AA2-2 are driven at a frequency of 30 Hz, first image data DATA1 is applied to the first area AA1 in every frame period, second-first image data DATA2-1 is applied to the second-first area AA2-1 in one frame period out of every four frame periods but is not applied in the remaining three frame periods, and second-second image data DATA2-2 is applied to the second-second area AA2-2 in one frame period out of every four frame periods but is not applied in the remaining three frame periods.

In this case, since the first area AA1, the second-first area AA2-1, and the second-second area AA2-2 are divided into different sizes, the periods during which the first image data DATA1, the second-first image data DATA2-1, and the second-second image data DATA2-2 are applied are formed differently for each frame period.

Herein, the case where the image data is not applied to the second area including the second-first area and the second-second area is described as an example, but is not limited thereto. For example, the image data may not be applied to the first area, or no image data can be applied to both the first and second areas. As described in FIGS. 2 and 3, in order to operate the divided areas at different driving frequencies using the frame skip, it can be possible to implement it by blocking a gate signal applied to the second area including the second-first area and the second-second area during the frame skip period.

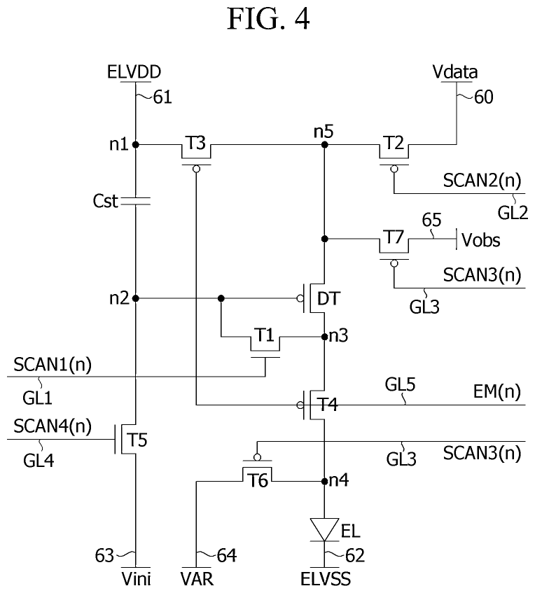

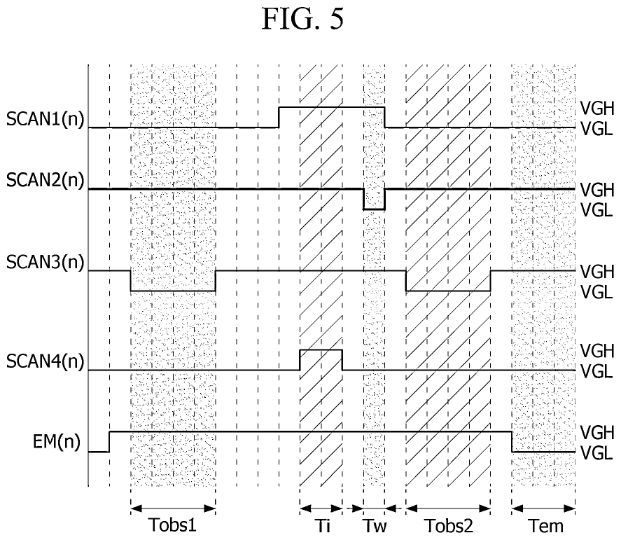

FIG. 4 is a diagram showing a pixel circuit according to a first embodiment of the present disclosure, and FIG. 5 is a diagram illustrating driving timings of the pixel circuit shown in FIG. 4.

Referring to FIGS. 4 and 5, a pixel circuit according to a first embodiment of the present disclosure includes a light-emitting element EL, a driving element DT for supplying a current to the light-emitting element EL, a plurality of switch elements T1, T2, T3, T4, T5, T6, and T7 for switching a current path connected to the driving element DT, and a first capacitor Cst for storing a gate-source voltage of the driving element DT. The driving element DT and the switch elements T2, T3, T4, T6, and T7 can be implemented as a P-channel oxide TFTs, and the switch elements T1 and T5 can be implemented as N-channel oxide TFTs.

The gate signals applied to this pixel circuit include a first scan signal SCAN1(n), a second scan signal SCAN2(n), a third scan signal SCAN3(n), a fourth scan signal SCAN4(n), and an EM signal EM(n). Here, n is a natural number.

The capacitor Cst is connected between a first node n1 and a second node n2. A pixel driving voltage ELVDD is supplied to the pixel circuit via an ELVDD wire 61. The first node n1 is connected to an ELVDD wire 61, a first electrode of a third switch element T3, and a first electrode of the capacitor Cst. The second node n2 is connected to a second electrode of the capacitor Cst, a gate electrode of the driving element DT, a first electrode of a first switch element T1, and a first electrode of a fifth switch element T5.

A first switch element T1 is turned on according to a gate-on voltage VGH of the first scan signal SCAN1 to connect a gate electrode and a second electrode of the driving element DT. The first switch element T1 includes a gate electrode connected to a first scan line GL1, the first electrode connected to the second node n2, and a second electrode connected to a third node n3. The first scan signal SCAN1(n) is applied to the pixels via the first gate line GL1. The third node n3 is connected to the second electrode of the driving element DT, the second electrode of the first switch element T1, and a first electrode of a fourth switch element T4.

A second switch element T2 is turned on according to a gate-on voltage VGL of the second scan signal SCAN2(n) to apply a data voltage Vdata to the first electrode of the driving element DT. The second switch element T2 includes a gate electrode connected to a second gate line GL2, a first electrode connected to the fifth node n5, and a second electrode connected to a data line 60. A fifth node n5 is connected to the first electrode of the driving element DT, the first electrode of the second switch element T2, and a second electrode of a third switch element T3.

The third switch element T3 supplies the pixel driving voltage ELVDD to the first electrode of the driving element DT in response to the EM signal EM(n). The third switch element T3 includes a gate electrode connected to an EM line GL5, the first electrode connected to the ELVDD wire 61, and the second electrode connected to the fifth node n5. The EM signal EM(n) is fed to the pixels via the EM line GL5.

The fourth switch element T4 is turned on according to a gate-on voltage VGL of the EM signal EM(n) to connect the second electrode of the driving element DT to an anode electrode of the light-emitting element EL. A gate electrode of the fourth switch element T4 is connected to the EM line GL5. The first electrode of the fourth switch element T4 is connected to the third node n3, and a second electrode of the fourth switch element T4 is connected to a fourth node n4. The fourth node n4 is connected to the anode electrode of the light-emitting element EL, the second electrode of the fourth switch element T4, and the second electrode of the sixth switch element T6.

The fifth switch element T5 is turned on according to a gate-on voltage VGH of the fourth scan signal SCAN4(n) to connect the second node n2 to a Vini wire 63 so that the capacitor Cst and the gate of the driving element DT are initialized during an initialization phase Ti. The fifth switch element T5 includes a gate electrode connected to a fourth scan line GL4, the first electrode connected to the second node n2, and a second electrode connected to the Vini wire 63. The fourth scan signal SCAN4(n) is fed to the pixels via the fourth scan line GL4. An initialization voltage Vini is supplied to the pixels via the Vini wire 63.

The sixth switch element T6 is turned on according to a gate-on voltage VGL of the third scan signal SCAN3(n) to connect a VAR wire 64 to the anode electrode of the light-emitting element EL during a first OBS phase Tobs1 and a second OBS phase Tobs2. During the first OBS phase Tobs1 and the second OBS phase Tobs2, the anode voltage of the light-emitting element EL is discharged to a reset voltage VAR through the sixth switch element T6. In this case, the light-emitting element EL does not emit light because the voltage between the anode and the cathode is less than its threshold voltage. The sixth switch element T6 includes a gate electrode connected to a third scan line GL3, the first electrode connected to the VAR wire 64, and a second electrode connected to the fourth node n4.

A seventh switch element T7 is turned on according to a gate-on voltage VGL of the third scan signal SCAN3(n) to apply a bias voltage Vobs by connecting a Vobs wire 65 to the fifth node n5 during the first OBS stage Tobs1 and the second OBS stage Tobs2. During the first OBS phase Tobs1 and the second OBS phase Tobs2, the voltage on the first electrode of the driving element DT is discharged to a bias voltage Vobs via a seventh switch element T7. The seventh switch element T7 includes a gate electrode connected to a third scan line GL3, a first electrode connected to the fifth node n5, and a second electrode connected to a Vobs wire 65.

The driving element DT drives the light-emitting element EL by regulating the current flowing to the light-emitting element EL according to a gate-source voltage Vgs. The driving element DT includes the gate electrode connected to the second node n2, the first electrode connected to the fifth node n5, and the second electrode connected to the third node n3.

The light-emitting element EL is connected between the fourth node n4 and an ELVSS wire 62. The light-emitting element EL can be implemented as an OLED. The OLED includes an organic compound layer formed between an anode and a cathode. The organic compound layer can include, but is not limited to, a hole injection layer (HIL), a hole transport layer (HTL), an emission layer (EML), an electron transport layer (ETL), and an electron injection layer (EIL). When a voltage is applied to the anode and the cathode of the OLED, holes passing through the hole transport layer (HTL) and electrons passing through the electron transport layer (ETL) move to the emission layer (EML) to form excitons, thereby causing visible light to be emitted from the emission layer (EML).

In the first OBS stage Tobs1, the seventh switch element T7 is turned on, discharging the voltage of the fifth node n5 to the bias voltage Vobs.

In the initialization phase Ti, the first switch element T1 and the fourth switch element T4 are turned on, discharging the voltages of the second node n2 and the third node n3 to the initialization voltage Vini.

In a data writing stage Tw, the second switch element T2 is turned on, so that the data voltage is applied to the fifth node n5 and the voltage of the second node n2 becomes a voltage of Vdata+Vth. A threshold voltage Vth of the driving element DT is sensed and charged to the capacitor Cst connected to the second node n2.

In the second OBS stage Tobs2, the seventh switch element T7 is turned on, discharging the voltage of the fifth node n5 to the bias voltage Vobs.

In a light emission stage Tem, the third switch element T3 and the fourth switch element T4 are turned on, so that a current flows through the driving element DT to the light emitting element EL to emit the light-emitting element EL.

Since the way of implementing the frame skip is not to output the gate signal, it can be possible to implement it by not outputting the first scan signal and the fourth scan signal among the five signals, namely the first to fourth scan signals and the EM signal, to the pixel circuit of FIG. 4. For example, during the frame skipping, the first switch element T1 and the fourth switch element T4 can be turned off so that the voltages of the second node n2 and the third node n3 are not initialized.

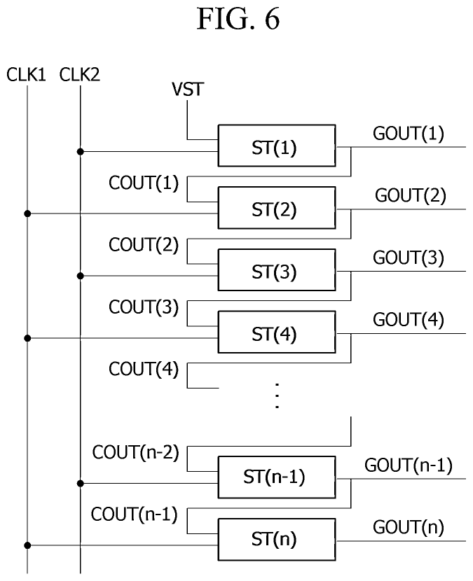

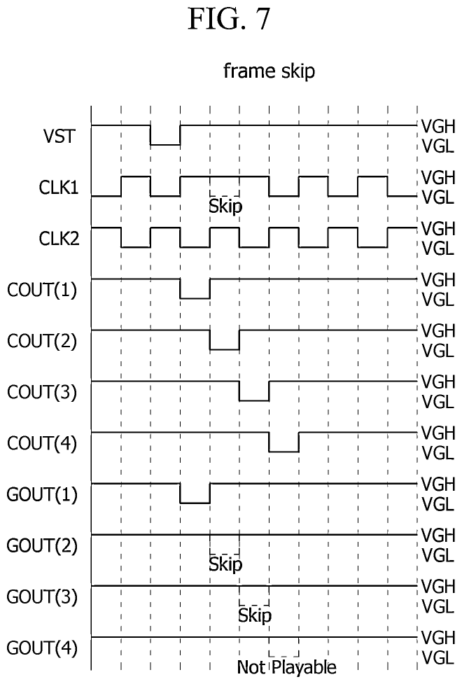

FIG. 6 is a diagram showing a shift register in a gate driver according to a comparative example, and FIG. 7 is a diagram illustrating driving waveforms of the gate driver shown in FIG. 6.

Referring to FIGS. 6 and 7, the gate driver according to an embodiment includes a plurality of signal transmission parts ST(1), ST(2), ST(3), ST(4), . . . , ST(n-1), and ST(n) connected in cascade via carry lines through which carry signals are transmitted.

Each of the signal transmission parts ST(1), ST(2), ST(3), ST(4), . . . , ST(n-1), and ST(n) receives a start pulse VST or a carry signal output from its preceding signal transmission part and a clock signal CLK2 or CLK1. A first signal transmission part ST(1) starts to drive according to the start pulse VST, and the other signal transmission parts ST(2), ST(3), ST(4), . . . , ST(n-1), and ST(n) start to drive by receiving carry signals COUT(1), COUT(2), COUT(3), COUT(4), . . . , COUT(n-2), and COUT(n-1) from their preceding signal transmission parts.

The signal transmission parts ST(1), ST(2), ST(3), ST(4), . . . , ST(n-1), and ST(n) shift the start pulse VST or the carry signals COUT(1), COUT(2), COUT(3), COUT(4), . . . , COUT(n-2), and COUT(n-1) output from their preceding signal transmission parts in synchronization with the timing of the clock signal to sequentially output the gate signals GOUT(1), GOUT(2), GOUT(3), GOUT(4), . . . , GOUT(n-1), GOUT(n), respectively.

In this case, as shown in FIG. 7, if a signal transmission part where the frame skip period is started modulates the clock signal at the time of outputting the gate signal so that the gate signal is not output, the carry signal is also not output from the signal transmission part, and then a subsequent signal transmission part also does not output its gate signal. For example, in order to block the outputs of signal transmission parts such as ST(2) and ST(3) and to resume the output of a signal transmission part such as ST(4), if the signal transmission part ST(2) is made not to output the gate signal by modulating the clock signal at the time when the signal transmission part ST(2) outputs the gate signal, then the carry signal is not output from the signal transmission part ST(2), which causes all the subsequent signal transmission parts ST(3), . . . , and ST(n) not to output their gate signals. Here, “not outputting the gate signal” means outputting a gate-off voltage.

Since the carry signal is not output, even though the clock signal is applied to a subsequent signal transmission part such as ST(4), it is impossible for the signal transmission part ST(4) to output its gate signal.

Thus, in the present embodiment, each of the signal transmission parts constituting the gate driver is configured to have two output circuits, a first output circuit and a second output circuit, the first output circuit receiving a start pulse or an (n-1)th carry signal and a clock signal and outputting an (n)th carry signal and the second output circuit receiving the (n)th carry signal and a clock signal and outputting an (n)th gate signal, so that the carry signal is still output to a subsequent signal transmission part regardless of whether the gate signal is output or not.

In this case, the first and second output circuits can share clock lines CL1, CL2 to which the clock signals are applied.

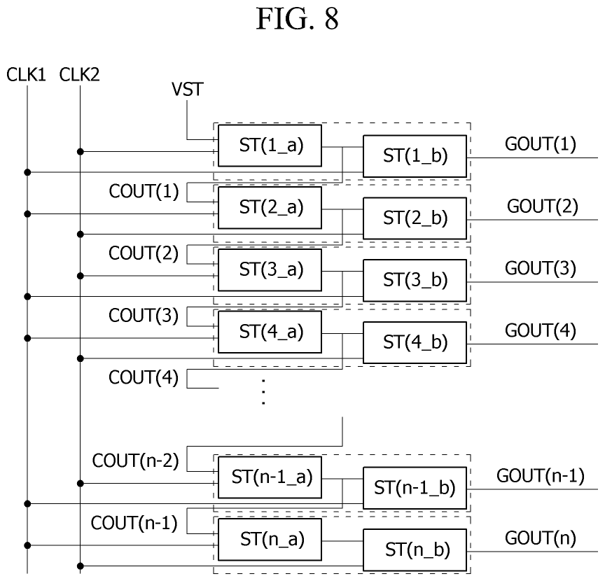

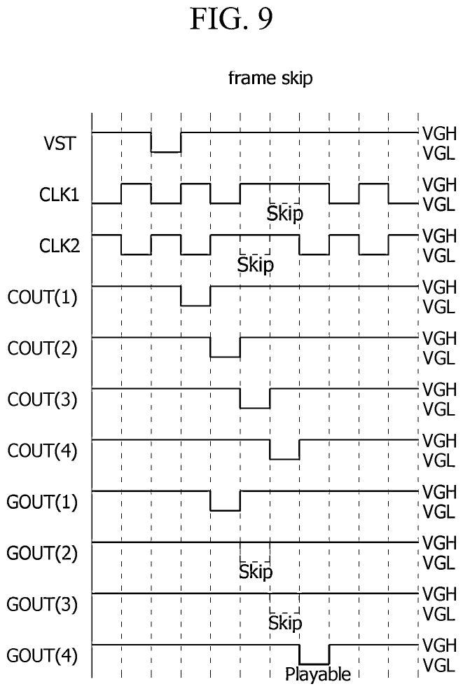

FIG. 8 is a diagram showing a shift register in a gate driver according to an embodiment, and FIG. 9 is a diagram illustrating driving waveforms of the gate driver shown in FIG. 8.

Referring to FIGS. 8 and 9, the gate driver according to an embodiment includes a plurality of signal transmission parts (ST(1_a), ST(1_b)),(ST(2_a), ST(2_b)),(ST(3_a), ST(3_b)), (ST(4_a), ST(4_b)), . . . ,(ST(n-1_a), ST(n-1_b)),(ST(n_a), ST(n_b)) connected in cascade via carry lines through which carry signals are transmitted.

In the embodiment, a pair of the output circuits in the respective signal transmission parts can be implemented as the same circuit, but are not necessarily limited thereto, and can be implemented as different circuits.

Each of the first output circuits ST(1_a), ST(2_a), ST(3_a), ST(4_a), . . . , ST(n-1_a), ST(n_a) among the signal transmission parts receives a start pulse VST or a carry signal output from its preceding signal transmission part and a clock signal CLK2 or CLK1. A first output circuit ST(1_a) starts to drive according to the start pulse VST, and the other output circuits ST(2_a), ST(3_a), ST(4_a), . . . , ST(n-1_a), and ST(n_a) start to drive by receiving carry signals COUT(1), COUT(2), COUT(3), COUT(4), . . . , COUT(n-2), and COUT(n-1) from their preceding signal transmission parts.

Among the first output circuits ST(1_a), ST(2_a), ST(3_a), ST(4_a), . . . , ST(n-1_a), and ST(n_a), odd-numbered first output circuits ST(1_a), ST(3_a), . . . , and ST(n-1_a) can be connected to a second clock line CL2 from which a second clock signal CLK2 is received, and even-numbered first output circuit ST(2_a), ST(4_a), . . . , and ST(n_a) can be connected to a first clock line CL1 from which a first clock signal CLK1 is received. The first and second clock signals can have opposite phases to each other.

Each of the second output circuits ST(1_b), ST(2_b), ST(3_b), ST(4_b), . . . , ST(n-1_b), ST(n_b) shift the start pulse VST or the carry signals COUT(1), COUT(2), COUT(3), COUT(4), . . . , COUT(n-2), and COUT(n-1) output from their preceding signal transmission parts in synchronization with the timing of the clock signal to sequentially output the gate signals GOUT(1), GOUT(2), GOUT(3), GOUT(4), . . . , GOUT(n-1), GOUT(n), respectively.

Among the second output circuits ST(1_b), ST(2_b), ST(3_b), ST(4_b), . . . , ST(n-1_b), and ST(n_b), odd-numbered second output circuits ST(1_b), ST(3_b), . . . , and St(n-1_b) can be connected to the first clock line CL1 from which the first clock signal CLK1 is received, and even-numbered second output circuits ST(2_b), ST(4_b), . . . , and ST(n_b) can be connected to the second clock line CL2 from which the second clock signal CLK2 is received.

The second clock signal CLK2 can be applied to the first output circuits that output odd-numbered gate signals, the first clock signal CLK1 can be applied to the second output circuits that output odd-numbered gate signals, the first clock signal CLK1 can be applied to the first output circuits that output even-numbered gate signals, and the second clock signal CLK2 can be applied to the second output circuits that output even-numbered gate signals. In other words, the first clock signal CLK1 and the second clock signal CLK2 with different phases can be alternately applied to each of the first output circuits and the second output circuits that output the gate signals.

In this case, as shown in FIG. 9, the carry signal can be output even though a signal transmission part in which the frame skip period is started modulates the clock signal at the time of outputting the gate signal so that the gate signal is not output. For example, in order to block the outputs of signal transmission parts such as ST(2) and ST(3) and to resume the output of a signal transmission part such as ST(4), the carry signal is still output even though the signal transmission parts ST(2) and ST(3) modulate the clock signal at the time when the signal transmission parts ST(2) and ST(3) output the gate signals so as not to output the gate signals.

Accordingly, the signal transmission part ST(4) can be able to output its gate signal again if the clock signal is restored at the time when the signal transmission part ST(4) outputs the gate signal.

As described above, in this embodiment, the clock signal can be modulated to block the outputs of the signal transmission parts only for a desired area, and then the clock signal can be restored to resume the outputs of the signal transmission parts in a subsequent area.

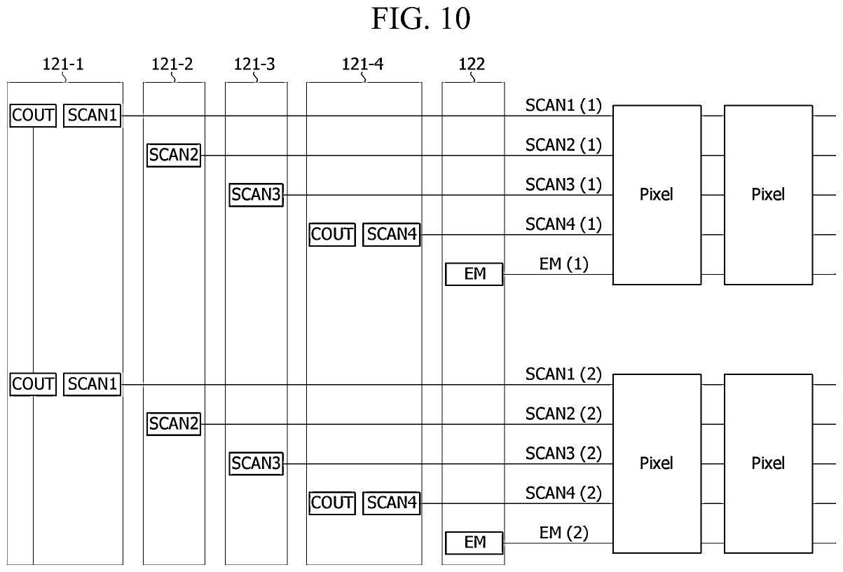

FIG. 10 is a diagram showing a gate driver that applies a gate signal to the pixel circuit shown in FIG. 4.

Referring to FIG. 10, the gate driver according to the embodiment can include a first scan driver 121-1, a second scan driver 121-2, a third scan driver 121-3, a fourth scan driver 121-4, and an EM driver 122. The first scan driver 121-1 and the fourth scan driver 121-4 are configured as shown in FIG. 8 so that the first scan signal and the fourth scan signal among the first to fourth scan signals and the EM signal are not output to the pixel circuit of FIG. 4 during the frame skipping.

For example, in the first scan driver 121-1 and the fourth scan driver 121-4, a signal transmission part for outputting a carry signal COUT and a signal transmission part for outputting a first scan signal SCAN1 or a signal transmission part for outputting a fourth scan signal SCAN4 can be configured separately, as shown in FIG. 8.

The second scan driver 121-2, the third scan driver 121-3, and the EM driver 122 are configured as shown in FIG. 6.

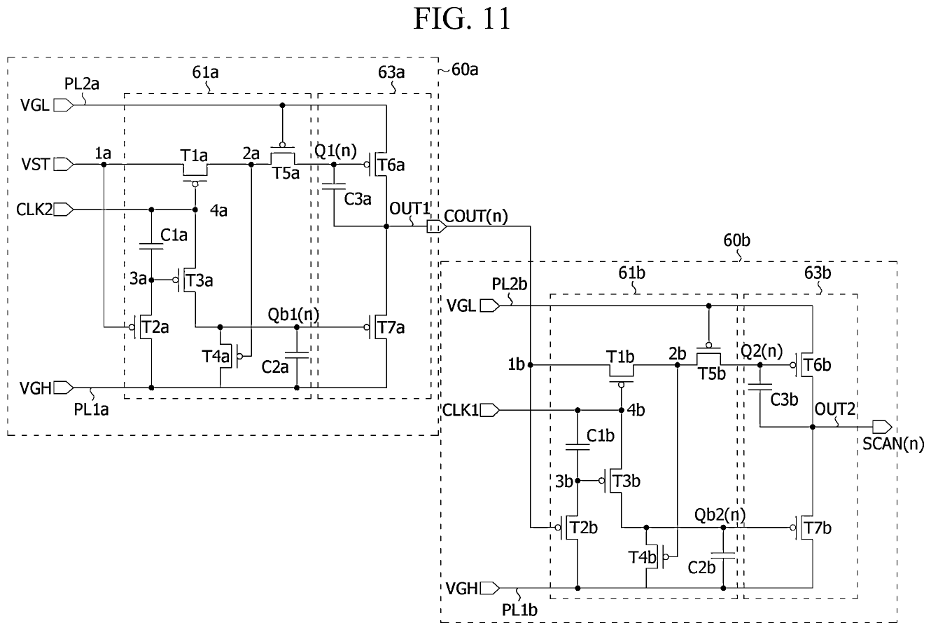

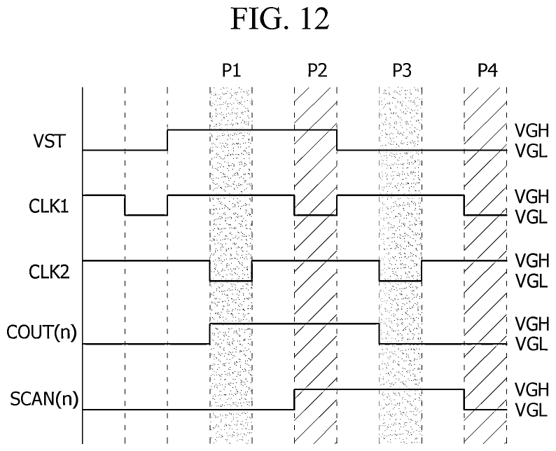

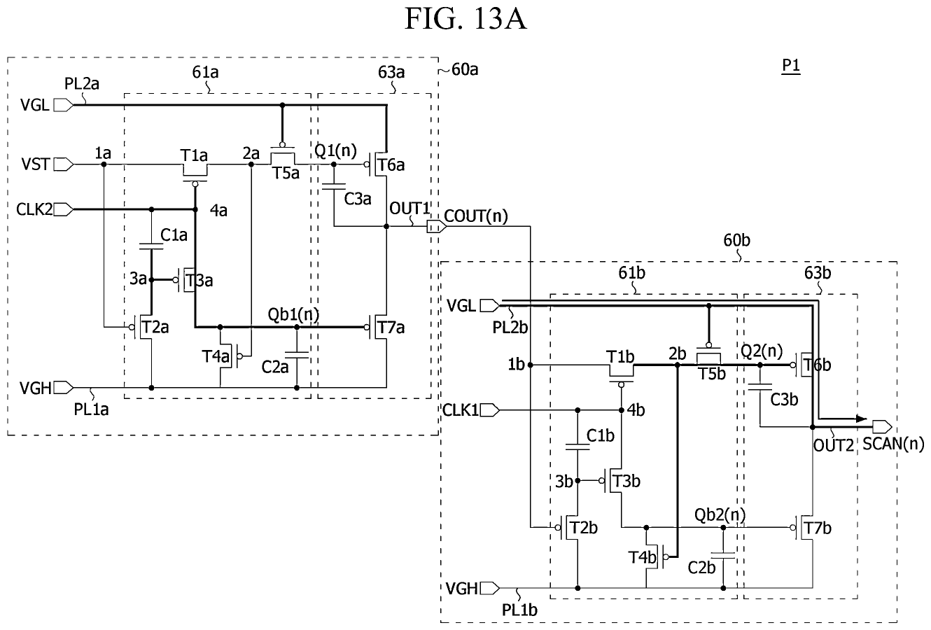

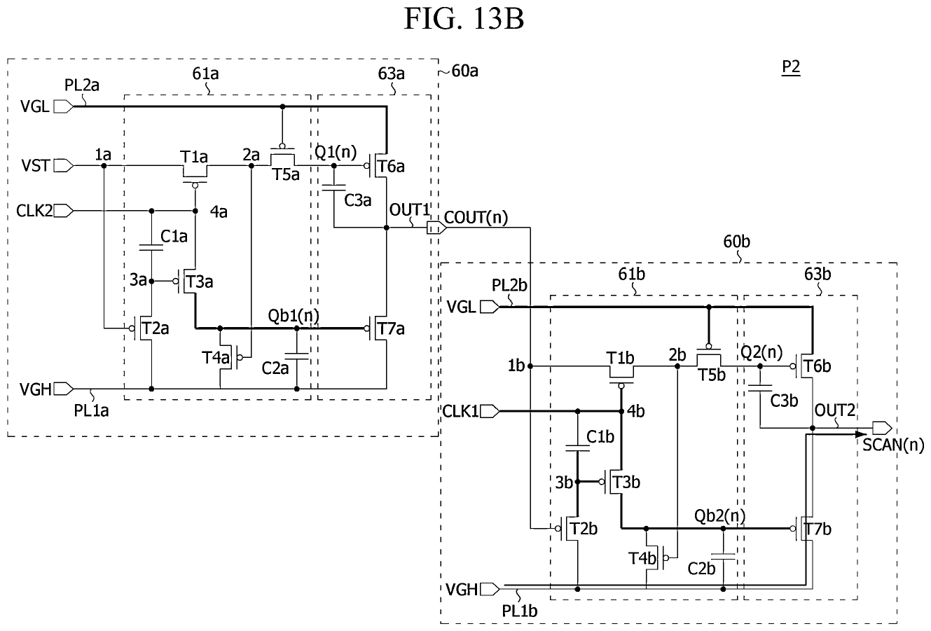

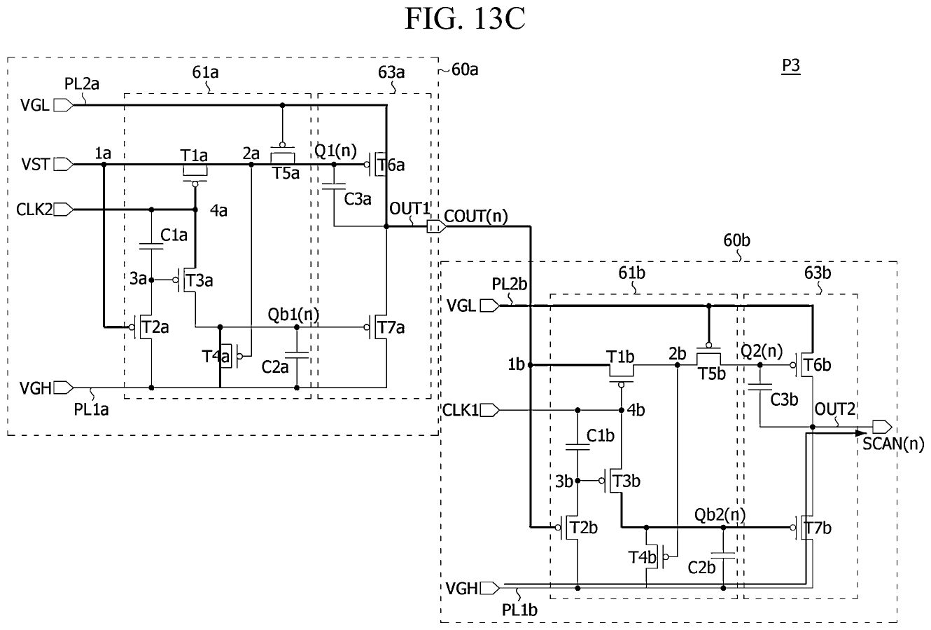

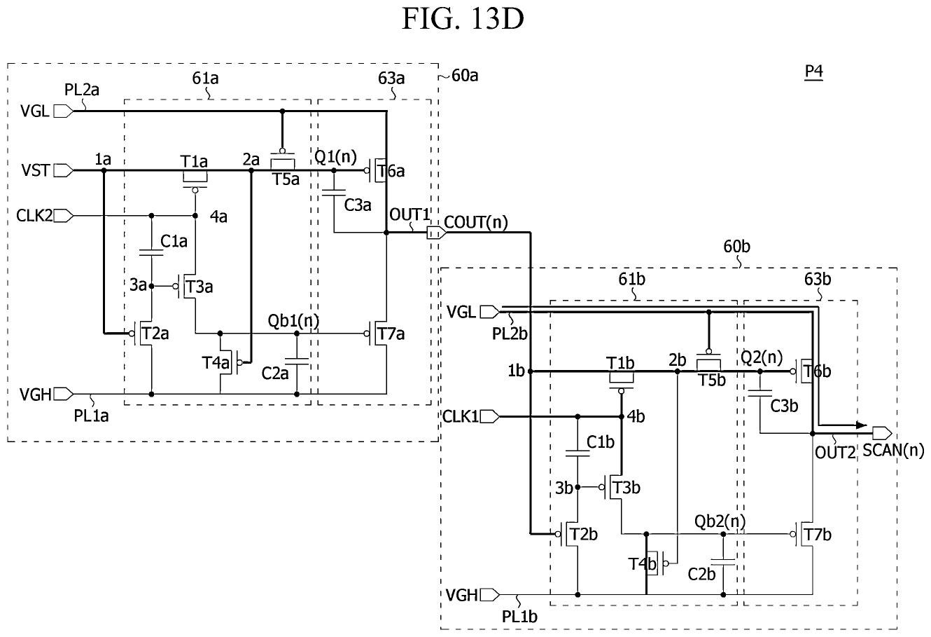

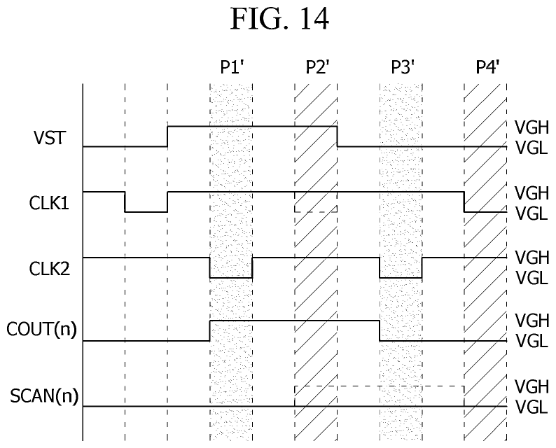

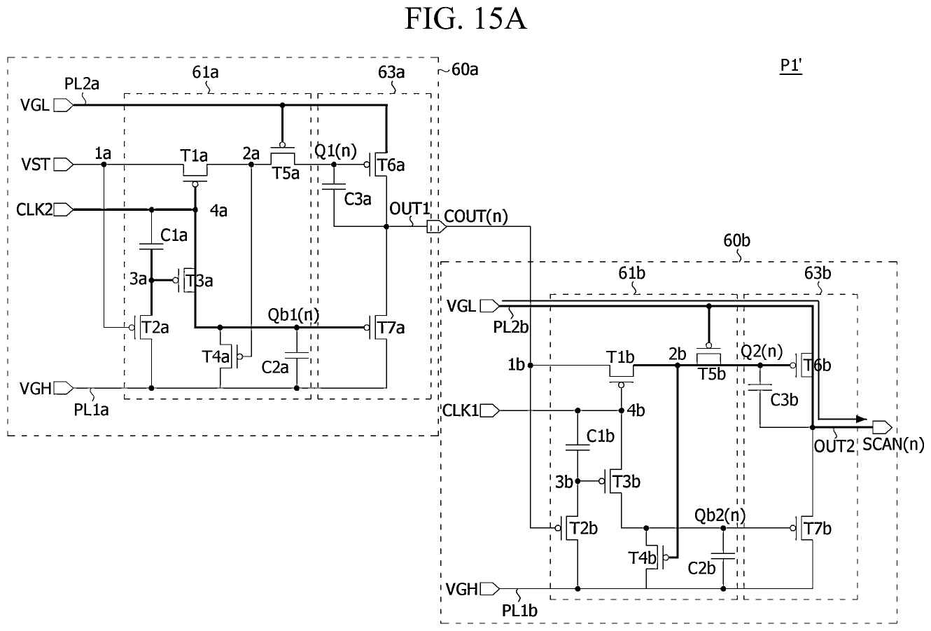

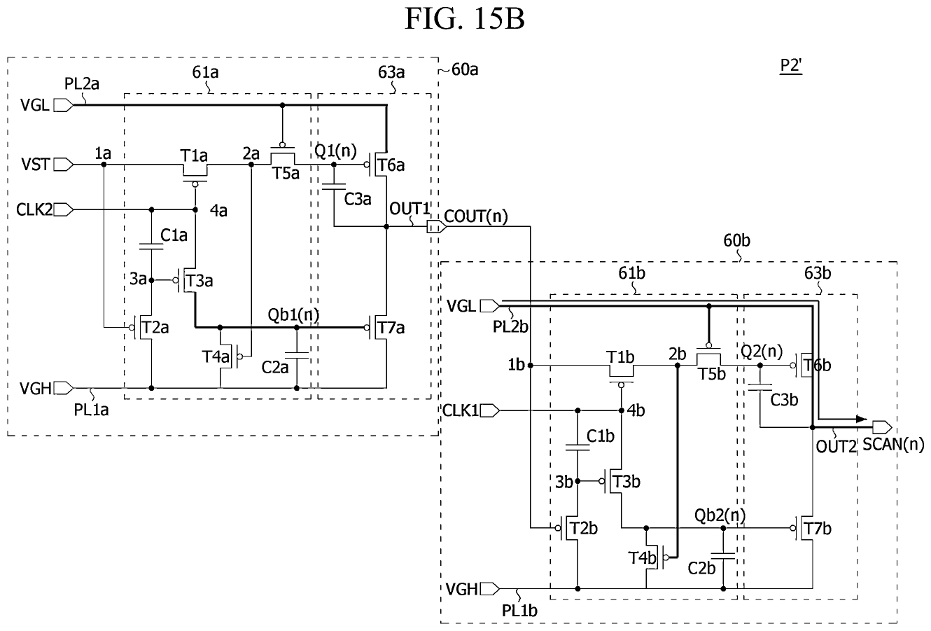

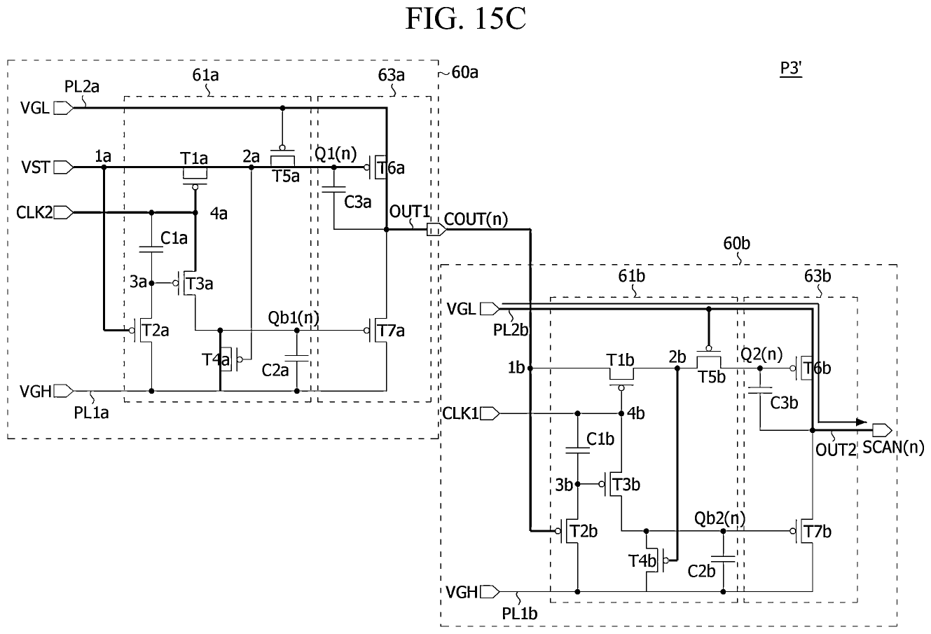

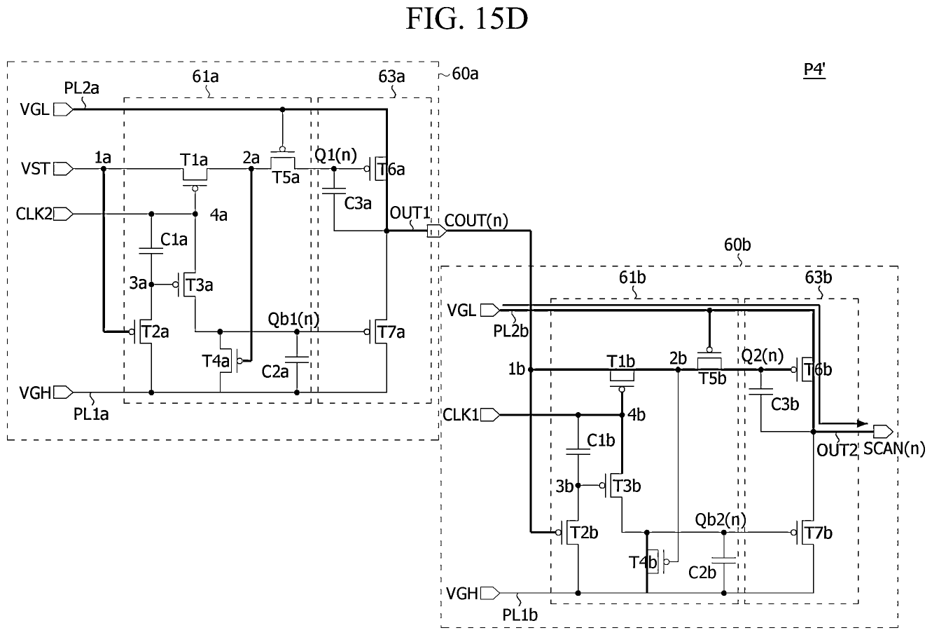

FIG. 11 is a diagram showing a gate driver according to a first embodiment, FIG. 12 is a diagram illustrating driving waveforms during normal driving of the gate driver shown in FIG. 11, FIGS. 13A to 13D are diagrams for describing an operating principle of the gate driver by way of the driving waveforms shown in FIG. 12, FIG. 14 is a diagram illustrating driving waveform during a frame skipping in the gate driver shown in FIG. 11, and FIGS. 15A to 15D are diagrams illustrating an operating principle of the gate driver by way of the driving waveforms shown in FIG. 14.

Referring to FIG. 11, a gate driver according to a first embodiment of the present disclosure can include a first output circuit 60a from which a carry signal is output, and a second output circuit 60b from which a scan signal is output.

The first output circuit 60a can include a first-first control node (hereinafter referred to as a “Q1(n) node”) at which an output voltage is pulled up, a first-second control node (hereinafter referred to as a “Qb1(n) node”) at which an output voltage is pulled down, a first circuit part 61a, and a second circuit part 63a.

The first circuit part 61a serves to control the charge and discharge of the first-first control node Q1(n) and the first-second control node Qb1(n). The first circuit part 61a can include a first-a transistor T1a, a second-a transistor T2a, a third-a transistor T3a, a fourth-a transistor T4a, a fifth-a transistor T5a, and a first-a capacitor C1a.

The first-a transistor T1a is turned on according to a clock signal CLK2 and connects a first-a node 1a to a second-a node 2a. The first-a transistor T1a includes a gate electrode to which the clock signal CLK2 is applied, a first electrode connected to the first-a node 1a, and a second electrode connected to the second-a node 2a.

The second-a transistor T2a is turned on according to a start signal VST or a previous carry signal C(n-1), and connects a third-a node 3a to a first-a power line PL1a to which a high potential voltage VGH is applied. The second-a transistor T2a includes a gate electrode to which the start signal VST or the preceding carry signal C(n-1) is applied, a first electrode connected to the third-a node 3a, and a second electrode connected to the first-a power line PL1a.

The third-a transistor T3a is turned on according to the voltage of the third-a node 3a, and connects a fourth-a node 4a to which the clock signal CLK2 is applied to the first-second control node Qb1(n). The third-a transistor T3a includes a gate electrode connected to the third-a node 3a, a first electrode connected to the fourth-a node 4a, and a second electrode connected to the first-second control node Qb1(n).

The fourth-a transistor T4a is turned on according to the voltage of the second-a node 2a, and connects the first-a power line PL1a to the first-second control node Qb1(n). The fourth-a transistor T4a includes a gate electrode connected to the second-a node 2a, a first electrode connected to the first-second control Qb1(n), and a second electrode connected to the first-a power line PL1a.

The fifth-a transistor T5a is turned on according to a low potential voltage VGL, and connects the second-a node 2a to the first-first control node Q1(n). The fifth-a transistor T5a includes a gate electrode connected to the second-a power line PL2a to which the low potential voltage is applied, a first electrode connected to the second-a node 2a, and a second electrode connected to the first-first control node Q1(n).

The first-a capacitor C1a is connected between the third-a node 3a and the fourth-a node 4a, and can turn on or turn off the third-a transistor T3a according to the clock signal when the second-a transistor T2a is turned off. A second-a capacitor C2a is connected between the first-second control node Qb1(n) and the first-a power line PL1a.

The second circuit part 63a can output a carry signal COUT(n) to an output node OUT1 based on the potentials of the first-first control node Q1(n) and the first-second control node Qb1(n). Here, the carry signal COUT(n) can be output to a preceding signal transmission part and the second output circuit 60b. The second circuit part 63a can include a sixth-a transistor T6a, a seventh-a transistor T7a, and a third-a capacitor C3a.

The sixth-a transistor T6a is turned on according to the voltage of the first-first control node Q1(n) and outputs the low potential voltage VGL to the output node OUT1. The sixth-a transistor T6a includes a gate electrode connected to the first-first control node Q1(n), a first electrode connected to the second-a power line PL2a, and a second electrode connected to the output node OUT1.

The seventh-a transistor T7a is turned on according to the voltage of the first-second control node Qb1(n) and outputs the high potential voltage VGH to the output node OUT1. The seventh-a transistor T7a includes a gate electrode connected to the first-second control node Qb1(n), a first electrode connected to the output node OUT1, and a second electrode connected to the first-a power line PL1a.

The third-a capacitor C3a can be connected between the gate electrode and the second electrode of the sixth-a transistor T6a.

The second output circuit 60b can include a second-first control node (hereinafter referred to as a “Q2(n) node”) at which an output voltage is pulled up, a second-second control node (hereinafter referred to as a “Qb2(n) node”) at which the output voltage is pulled down, a third circuit part 61b, and a fourth circuit part 63b.

The third circuit part 61b serves to control the charge and discharge of the second-first control node Q2(n) and the second-second control node Qb2(n). The third circuit part 61b can include a first-b transistor T1b, a second-b transistor T2b, a third-b transistor T3b, a fourth-b transistor T4b, a fifth-b transistor T5b, and a first-b capacitor C1b.

The first-b transistor T1b is turned on according to a clock signal CLK1 and connects a first-b node 1b to a second-b node 2b. The first-b transistor T1b includes a gate electrode to which the clock signal CLK1 is applied, a first electrode connected to the first-b node 1b, and a second electrode connected to the second-b node 2b.

The second-b transistor T2b is turned on according to the carry signal COUT(n), and connects a third-b node 3b to a first-b power line PL1b to which the high potential voltage VGH is applied. The second-b transistor T2b includes a gate electrode to which the carry signal COUT(n) is applied, a first electrode connected to the third-b node 3b, and a second electrode connected to the first-b power line PL1b.

The third-b transistor T3b is turned on according to the voltage of the third-b node 3b and connects a fourth-b node 4b to which the clock signal CLK1 is applied to the second-second control node Qb2(n). The third-b transistor T3b includes a gate electrode connected to the third-b node 3b, a first electrode connected to the fourth-b node 4b, and a second electrode connected to the second-second control node Qb2(n).

The fourth-b transistor T4b is turned on according to the voltage of the second-b node 2b and connects the second-second control node Qb2(n) to the first-b power line PL1b. The fourth-b transistor T4b includes a gate electrode connected to the second-b node 2b, a first electrode connected to the second-second control Qb2(n), and a second electrode connected to the first-b power line PL1b.

The fifth-b transistor T5b is turned on according to the low potential voltage VGL, and connects the second-b node 2b to the second-first control node Q2(n). The fifth-b transistor T5b includes a gate electrode connected to the second-b power line PL2b to which the low potential voltage is applied, a first electrode connected to the second-b node 2b, and a second electrode connected to the second-first control node Q2(n).

The first-b capacitor C1b is connected between the third-b node 3b and the fourth-b node 4b, and the second-b capacitor C2b is connected between the second-second node Qb2(n) and the first-b power line PL1b.

The fourth circuit part 63b can output a scan signal SCAN(n) to an output node OUT2 based on the potentials of the second-first control node Q2(n) and the second-second control node Qb2(n). Here, the scan signal SCAN(n) can be output to the output node OUT2. The fourth circuit part 63b can include a sixth-b transistor T6b, a seventh-b transistor T7b, and a third-b capacitor C3b.

The sixth-b transistor T6b is turned on according to the voltage of the second-first control node Q2(n), and outputs the low potential voltage VGL to the output node OUT2. The sixth-b transistor T6b includes a gate electrode connected to the second-first control node Q2(n), a first electrode connected to the second-b power line PL2b, and a second electrode connected to the output node OUT2.

The seventh-b transistor T7b is turned on according to the voltage of the second-second control node Qb2(n) and outputs the high potential voltage VGH to the output node OUT2. The seventh-b transistor T7b includes a gate electrode connected to the second-second control node Qb2(n), a first electrode connected to the output node OUT2, and a second electrode connected to the first-b power line PL1b.

The third-b capacitor C3b can be connected between the gate electrode and the second electrode of the sixth-b transistor T6b.

The gate driver according to the embodiment can perform the frame skip by the clock signals CLK1 and CLK2.

When no frame skip is performed as shown in FIG. 12, the clock signal CLK1 is not modulated during a second period P2, and thus the scan signal SCAN(n) is output at a high level from the second output circuit 60b.

Referring to FIG. 12 and FIGS. 13A to 13D, the gate driver according to the embodiment can operate with driving waveforms divided into a first period P1, a second period P2, a third period P3, and a fourth period P4. The bold lines indicate that the gate-on voltage is applied during each period.

In the first period P1, the clock signal CLK2 can be applied at a low level to the first output circuit 60a of the gate driver, from which the carry signal can be output at a high level, and the clock signal CLK1 is applied at a high level to the second output circuit 60b of the gate driver, from which the scan signal can be output at a low level.

In the second period P2, the clock signal CLK2 can be applied at a high level to the first output circuit 60a of the gate driver, from which the carry signal can be output at a high level, and the clock signal CLK1 is applied at a low level to the second output circuit 60b of the gate driver, from which the scan signal can be output at a high level.

In the third period P3, the clock signal CLK2 can be applied at a low level to the first output circuit 60a of the gate driver, from which the carry signal can be output at a low level, and the clock signal CLK1 is applied at a high level to the second output circuit 60b of the gate driver, from which the scan signal can be output at a high level.

In the fourth period P4, the clock signal CLK2 can be applied at a high level to the first output circuit 60a of the gate driver, from which the carry signal can be output at a low level, and the clock signal CLK1 is applied at a low level to the second output circuit 60b of the gate driver, from which the scan signal can be output at a low level.

When the frame skip is performed, the clock signal CLK1 is modulated from a low level indicated by the dotted line to a high level indicated by the solid line during the second period P2′, causing the scan signal SCAN(n) to be output at a low level from the second output circuit 60b, as shown in FIG. 14.

Accordingly, since the first scan signal and the second scan signal are applied at low levels from the gate driver to the pixel circuit of FIG. 4, the first switch element and the fifth switch element are turned off.

The clock signals CLK1 and CLK2 are modulated during the frame skip period, causing the scan signal to be output at a low level; and therefore the data driver does not apply a data voltage.

Referring to FIG. 14 and FIGS. 15A to 15D, the gate driver according to the embodiment can operate with driving waveforms divided into a first period P1′, a second period P2′, a third period P3′, and a fourth period P4′. The bold lines indicate that the gate-on voltage is applied during each period.

In the first period P1′, the clock signal CLK2 can be applied at a low level to the first output circuit 60a of the gate driver, from which the carry signal can be output at a high level, and the clock signal CLK1 is applied at a high level to the second output circuit 60b of the gate driver, from which the scan signal can be output at a low level.

In the second period P2′, the clock signal CLK2 can be applied at a high level to the first output circuit 60a of the gate driver, from which the carry signal can be output at a high level, and the clock signal CLK1 can be modulated at a high level in the second output circuit 60b of the gate driver, from which the scan signal can be output at a low level, not at a high level.

In the third period P3′, the clock signal CLK2 can be applied at a low level to the first output circuit 60a of the gate driver, from which the carry signal can be output at a low level, and the clock signal CLK1 can be applied at a high level to the second output circuit 60b of the gate driver, from which the scan signal can be output at a low level.

In the fourth′ period P4′, the clock signal CLK2 can be applied at a high level to the first output circuit 60a of the gate driver, from which the carry signal can be output at a low level, and the clock signal CLK1 is applied at a low level to the second output circuit 60b of the gate driver, from which the scan signal can be output at a low level.

During the first to fourth periods P1′ to P4′, the scan signal can be output at the low level from the gate driver.

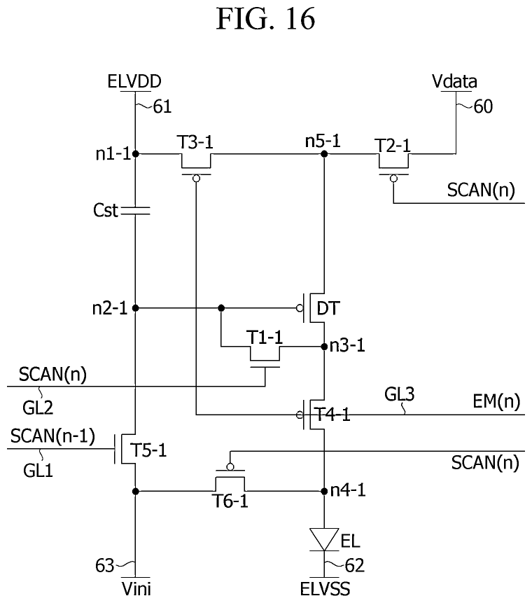

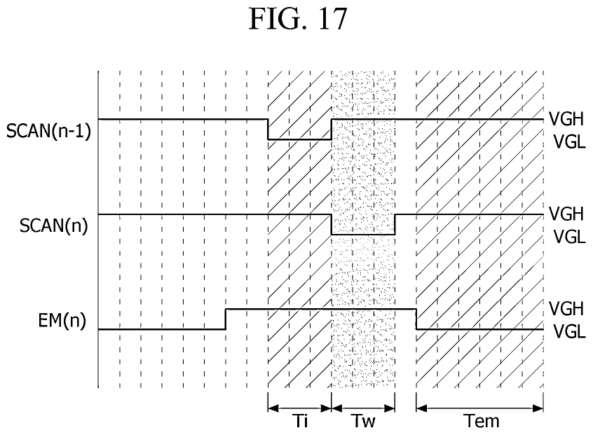

FIG. 16 is a diagram showing a pixel circuit according to a second embodiment, and FIG. 17 is a diagram illustrating driving timings of the pixel circuit shown in FIG. 16.

Referring to FIGS. 16 and 17, a pixel circuit according to a second embodiment of the present disclosure includes a light-emitting element EL, a driving element DT for supplying a current to the light-emitting element EL, a plurality of switch elements T1-1, T2-1, T3-1, T4-1, T5-1, and T6-1 for switching a current path connected to the driving element DT, and a first capacitor Cst for storing a gate-source voltage of the driving element DT. The driving element DT and the switch elements T1-1, T2-1, T3-1, T4-1, T5-1, and T6-1 can be implemented as a P-channel oxide TFTs.

The gate signals applied to this pixel circuit include the nth scan signal SCAN(n), the (n-1)th scan signal SCAN(n-1), and an EM signal EM(n). Here, n is a natural number.

The capacitor Cst is connected between a first-first node n1-1 and a second-first node n2-1. A pixel driving voltage ELVDD is supplied to the pixel circuit via an ELVDD wire 61. The first-first node n1-1 is connected to an ELVDD wire 61, a first electrode of a third-first switch element T3-1, and a first electrode of the capacitor Cst. The second-first node n2-1 is connected to a second electrode of the capacitor Cst, a gate electrode of the driving element DT, a first electrode of a first-first switch element T1-1, and a first electrode of a fifth-first switch element T5-1.

A first-first switch element T1-1 is turned on according to a gate-on voltage VGL of the nth scan signal SCAN(n) to connect a gate electrode and a second electrode of the driving element DT. The first-first switch element T1-1 includes a gate electrode connected to a second scan line GL2, the first electrode connected to the second-first node n2-1, and a second electrode connected to a third-first node n3-1. The nth scan signal SCAN(n) is applied to the pixels via the second scan line GL2. The third-first node n3-1 is connected to the second electrode of the driving element DT, the second electrode of the first-first switch element T1-1, and a first electrode of a fourth-first switch element T4-1.

A second-first switch element T2-1 is turned on according to a gate-on voltage VGL of the nth scan signal SCAN(n) to apply a data voltage Vdata to the first electrode of the driving element DT. The second-first switch element T2-1 includes a gate electrode connected to a second gate line GL2, a first electrode connected to the fifth-first node n5-1, and a second electrode connected to a data line 60. A fifth-first node n5-1 is connected to the first electrode of the driving element DT, the first electrode of the second-first switch element T2-1, and a second electrode of a third-first switch element T3-1.

The third-first switch element T3-1 supplies the pixel driving voltage ELVDD to the first electrode of the driving element DT in response to the EM signal EM(n). The third-first switch element T3-1 includes a gate electrode connected to an EM line GL3, the first electrode connected to the ELVDD wire 61, and the second electrode connected to the fifth-first node n5-1. The EM signal EM(n) is fed to the pixels via the EM line GL3.

The fourth-first switch element T4-1 is turned on according to a gate-on voltage VGL of the EM signal EM(n) to connect the second electrode of the driving element DT to an anode electrode of the light-emitting element EL. A gate electrode of the fourth-first switch element T4-1 is connected to the EM line GL3. The first electrode of the fourth-first switch element T4-1 is connected to the third-first node n3-1, and a second electrode of the fourth-first switch element T4-1 is connected to a fourth-first node n4-1. The fourth-first node n4-1 is connected to the anode electrode of the light-emitting element EL, the second electrode of the fourth-first switch element T4-1, and the second electrode of the sixth-first switch element T6-1.

The fifth-first switch element T5-1 is turned on according to a gate-on voltage VGL of the (n-1)th scan signal SCAN(n-1) to connect the second-first node n2-1 to a Vini wire 63 so that the capacitor Cst and the gate of the driving element DT are initialized during an initialization phase Ti. The fifth-first switch element T5-1 includes a gate electrode connected to a first scan line GL1, the first electrode connected to the second-first node n2-1, and a second electrode connected to the Vini wire 63. The (n-1)th scan signal SCAN(n-1) is fed to the pixels via the first scan line GL1. An initialization voltage Vini is supplied to the pixels via the Vini wire 63.

The sixth-first switch element T6-1 is turned on according to a gate-on voltage VGL of the nth scan signal SCAN(n) to connect a Vini wire 63 to the anode electrode of the light-emitting element EL. The sixth-first switch element T6-1 includes a gate electrode connected to a second scan line GL2, the first electrode connected to the Vini wire 63, and a second electrode connected to the fourth-first node n4-1.

The driving element DT drives the light-emitting element EL by regulating the current flowing to the light-emitting element EL according to a gate-source voltage Vgs. The driving element DT includes the gate electrode connected to the second-first node n2-1, the first electrode connected to the fifth-first node n5-1, and the second electrode connected to the third-first node n3-1.

The light-emitting element EL is connected between the fourth-first node n4-1 and an ELVSS wire 62. The light-emitting element EL can be implemented as an OLED. The OLED includes an organic compound layer formed between an anode and a cathode. The organic compound layer can include, but is not limited to, a hole injection layer (HIL), a hole transport layer (HTL), an emission layer (EML), an electron transport layer (ETL), and an electron injection layer (EIL). When a voltage is applied to the anode and the cathode of the OLED, holes passing through the hole transport layer (HTL) and electrons passing through the electron transport layer (ETL) move to the emission layer (EML) to form excitons, thereby causing visible light to be emitted from the emission layer (EML).

In an initialization phase Ti, a fifth-first switch element T5-1 is turned on so that the voltage of the second-first node n2-1 is discharged to the initialization voltage Vini.

In a data writing stage Tw, a first-first switch element T1-1, a second-first switch element T2-1, and a sixth-first switch element T6-1 are turned on, so that a data voltage is applied to a fifth-first node n5-1 and the voltage of a second-first node n2-1 becomes a voltage of Vdata+Vth. The threshold voltage Vth of the driving element is sensed and charged to a capacitor Cst connected to the second-first node n2-1.

In a light emission stage Tem, a third-first switch element T3-1 and a fourth-first switch element T4-1 are turned on, so that a current flows to the light-emitting element EL through the driving element DT to emit the light-emitting element EL.

Since the way of implementing the frame skip is not to output the gate signal, it can be possible to implement it by not outputting the (n-1)th and the (n)th scan signals among three signals, such as the (n-1)th to the (n)th scan signals and the EM signal, to the pixel circuit of FIG. 16. For example, the first-first switch element T1-1, the second-first switch element T2-1, the fifth-first switch element T5-1, and the sixth-first switch element T6-1 are turned off so that the voltages of the second-first node n2-1 and a third-first node n3-1 are not initialized during the frame skipping.

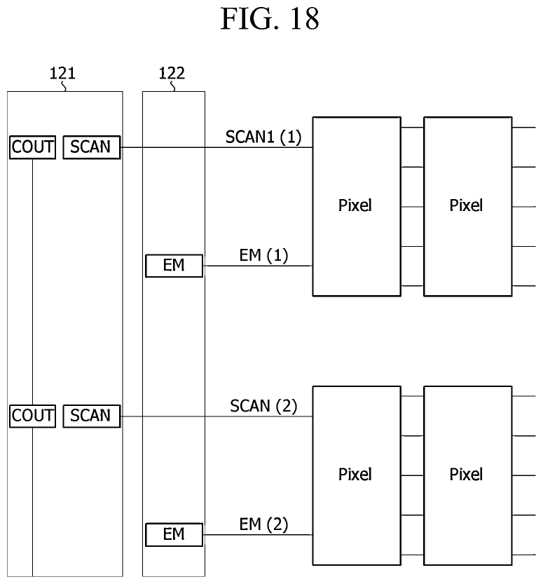

FIG. 18 is a diagram showing a gate driver that applies a gate signal to the pixel circuit shown in FIG. 16.

Referring to FIG. 18, the gate driver according to the embodiment can include a scan driver 121 and an EM driver 122. The scan driver 121 is configured as shown in FIG. 8 so that the scan sign between the scan signal and the EM signal is not output to the pixel circuit of FIG. 16 during the frame skipping.

For example, in the scan driver 121, a signal transmission part that outputs a carry signal COUT and a signal transmission part that outputs a scan signal SCAN can be configured separately, as shown in FIG. 8. Meanwhile, the EM driver 122 that outputs the EM signal is configured as shown in FIG. 6.

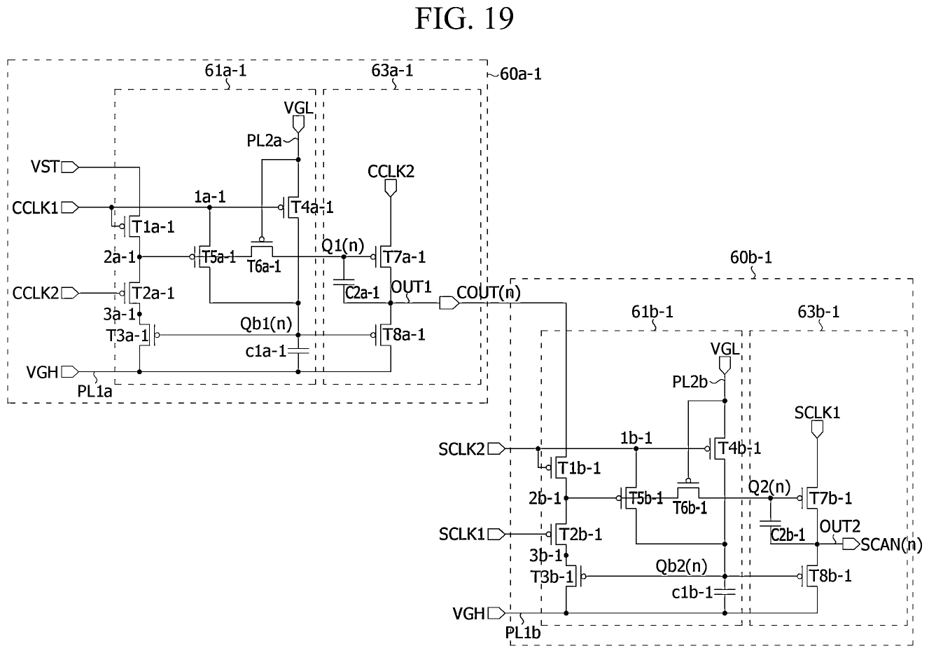

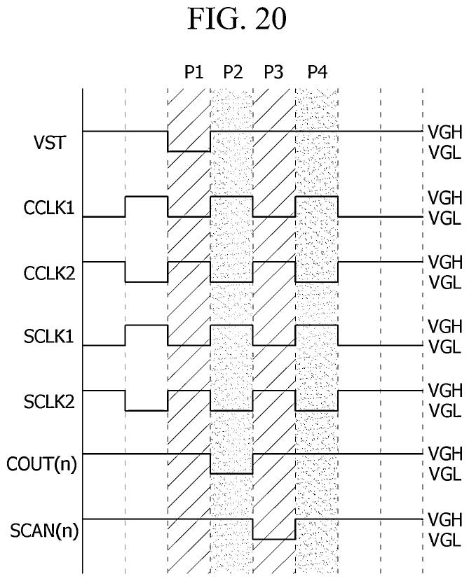

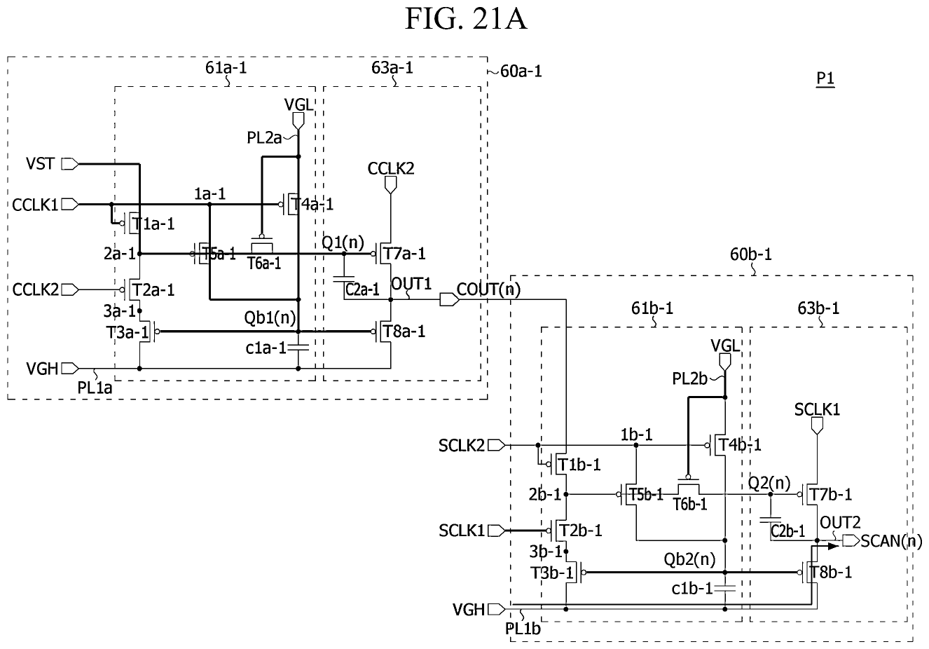

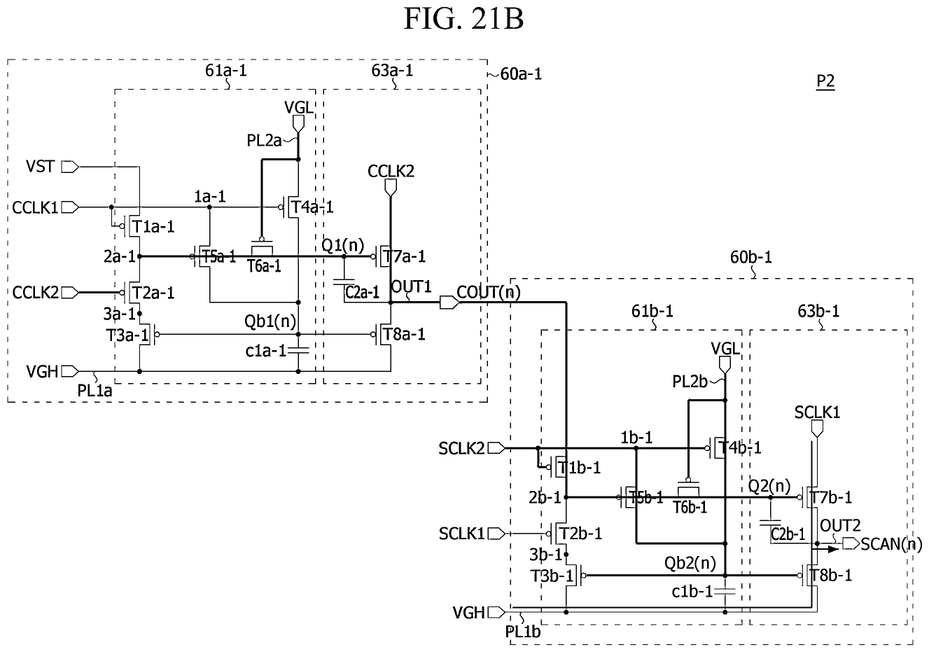

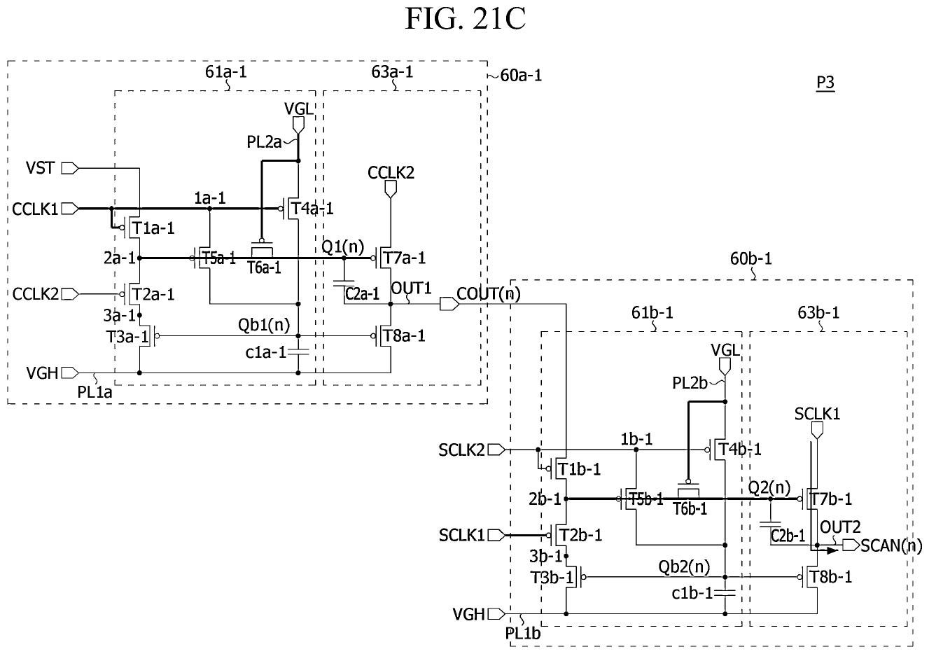

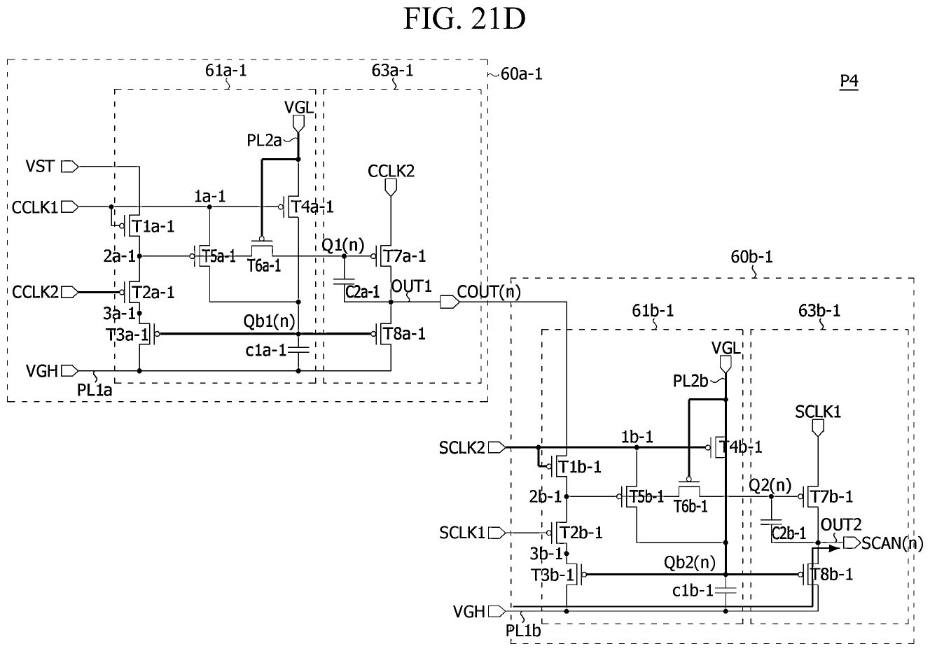

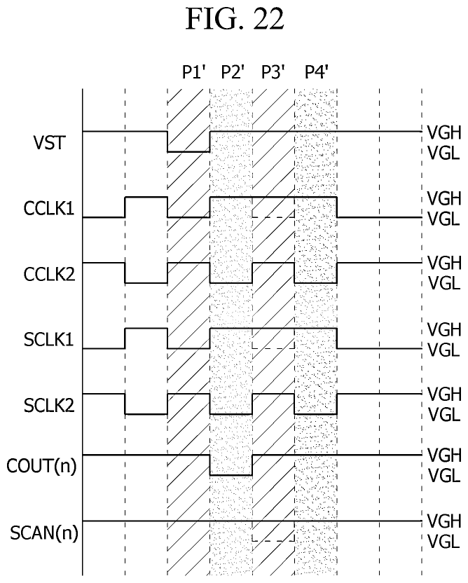

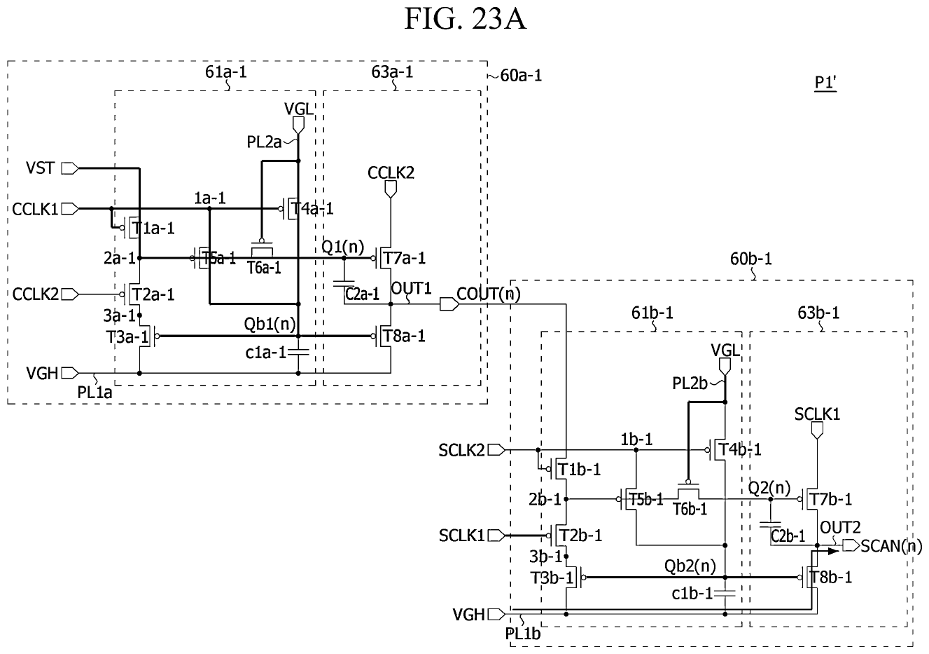

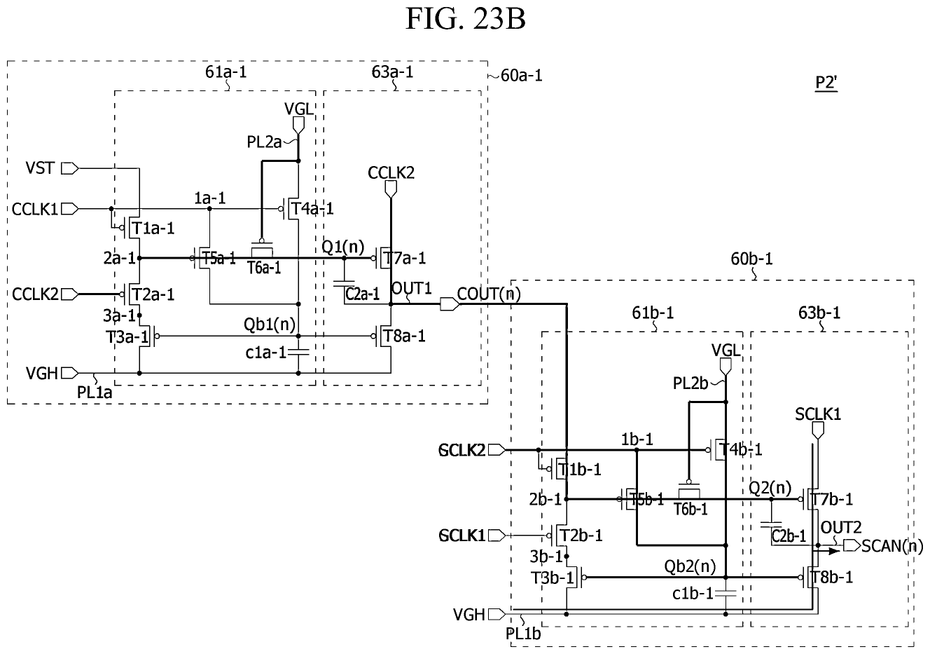

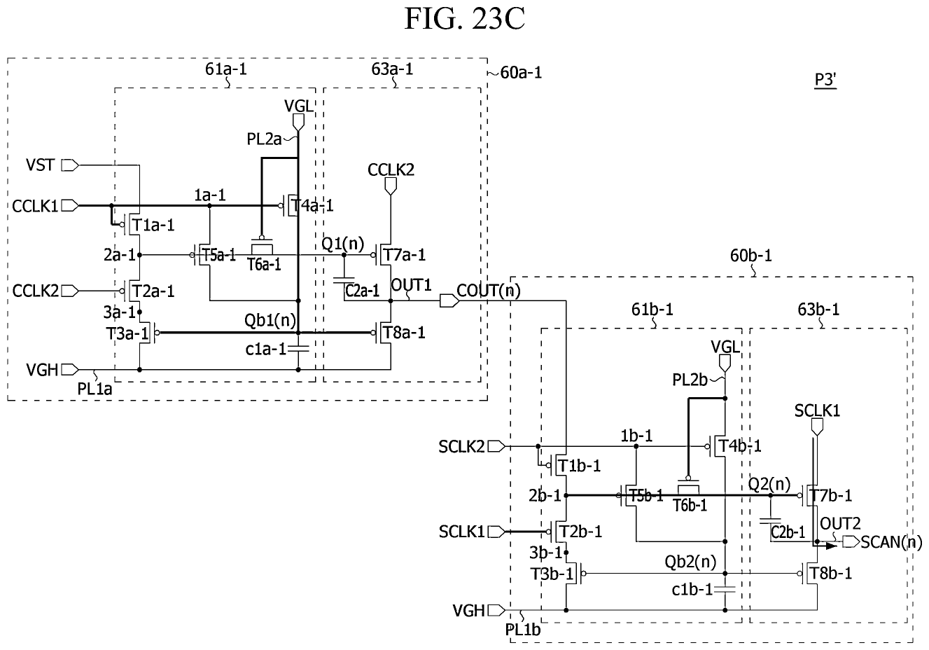

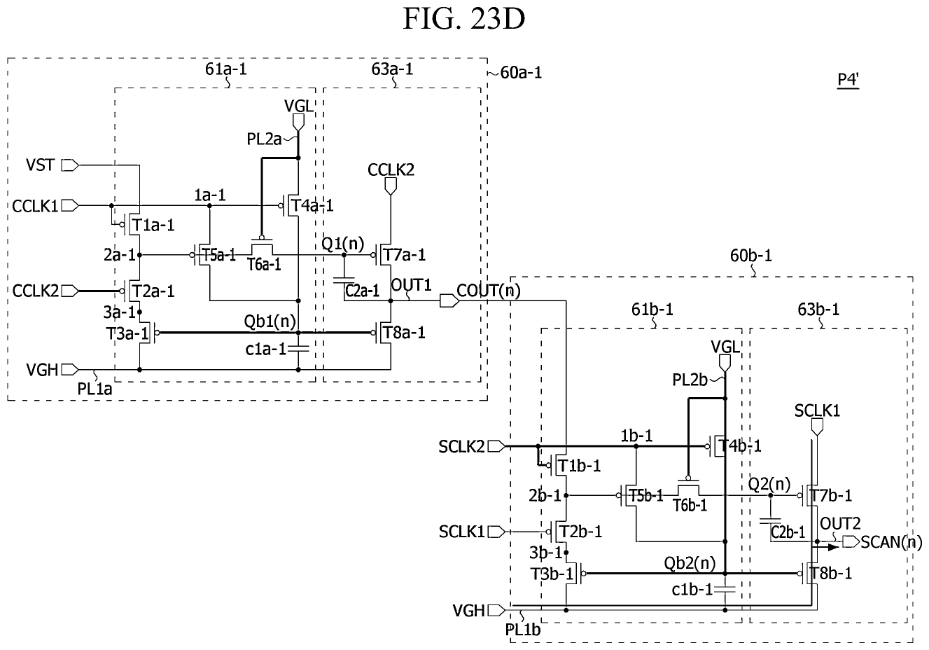

FIG. 19 is a diagram illustrating a gate driver according to a second embodiment, FIG. 20 is a diagram illustrating driving waveforms during normal driving in the gate driver shown in FIG. 19, FIGS. 21A to 21D are diagrams illustrating an operating principle of the gate driver by way of the driving waveforms shown in FIG. 20, FIG. 22 is a diagram illustrating driving waveform during a frame skip in the gate driver shown in FIG. 19, and FIGS. 23A to 23D are diagrams illustrating an operating principle of the gate driver by way of the driving waveforms shown in FIG. 22.

Referring to FIG. 19, a gate driver according to a second embodiment of the present disclosure can include a first output circuit 60a-1 from which a carry signal is output, and a second output circuit 60b-1 from which a scan signal is output.

The first output circuit 60a can include a first-first control node (hereinafter referred to as a “Q1 node”) at which an output voltage is pulled up, a first-second control node (hereinafter referred to as a “Qb1 node”) at which an output voltage is pulled down, a first circuit part 61a-1, and a second circuit part 63a-1.

The first circuit part 61a-1 serves to control the charge and discharge of the first-first control node Q1(n) and the first-second control node Qb1(n). The first circuit part 61a can include a first-a-first transistor T1a-1, a second-a-first transistor T2a-1, a third-a-first transistor T3a-1, a fourth-a-first transistor T4a-1, a fifth-a-first transistor T5a-1, a sixth-a-first transistor T6a-1, and a first-a-first capacitor C1a-1.

A first-a-first transistor T1a-1 is turned on according to a carry clock signal CCLK1 and applies a start signal VST to a second-a-first node 2a-1. The first-a-first transistor T1a-1 includes a gate electrode to which the carry clock signal CCLK1 is applied, a first electrode to which the start signal VST is applied, and a second electrode connected to the second-a-first node 2a-1.

A second-a-first transistor T2a-1 is turned on according to a carry clock signal CCLK2 and connects the second-a-first node 2a-1 to a third-a-first node 3a-1. The second-a-first transistor T2a-1 includes a gate electrode to which the carry clock signal CCLK2 is applied, a first electrode connected to the second-a-first node 2a-1, and a second electrode connected to the third-a-first node 3a-1.

A third-a-first transistor T3a-1 is turned on according to the voltage of the first-second control node Qb1(n) and connects to a third-a-first node 3a-1 to a first-a power line PL1a to which the high potential voltage VGH is applied. The third-a-first transistor T3a includes a gate electrode connected to the first-second control node Qb1(n), a first electrode connected to the third-a-first node 3a-1, and a second electrode connected to the first-a power line PL1a.

A fourth-a-first transistor T4a-1 is turned on according to the carry clock signal CCLK1 and applies a low potential voltage VGL to the first-second control node Qb1(n). The fourth-a-1 transistor T4a-1 includes a gate electrode to which the carry clock signal CCLK1 is applied, a first electrode connected to a second-a power line PL2a to which the low potential voltage VGL is applied, and a second electrode connected to the first-second control node Qb1(n).

A fifth-a-first transistor T5a-1 is turned on according to the voltage of the second-a-first node 2a-1 and connects the first-a-first node 1a-1 and the first-second control node Qb1(n). The fifth-a-first transistor T5a-1 includes a gate electrode connected to the second-a-first node 2a-1, a first electrode connected to the first-a-first node 1a-1, and a second electrode connected to the first-second control node Qb1(n).

A sixth-a-first transistor T6a-1 is turned on according to the low potential voltage VGL and connects the second-a-first node 2a-1 to the first-first control node Q1(n). The sixth-a-first transistor T6a-1 includes a gate electrode to which the low potential voltage VGL is applied, a first electrode connected to the second-a-first node 2a-1, and a second electrode connected to the first-first control node Q1(n).

The first-a-first capacitor C1a-1 is connected between the first-second control node Qb1(n) and the first-a power line PL1a.

The second circuit part 63a-1 can output a carry signal COUT(n) to an output node OUT1 based on the potentials of the first-first control node Q1(n) and the first-second control node Qb1(n). Here, the carry signal COUT(n) can be output to a preceding signal transmission part and the second output circuit 60b-1. The second circuit part 63a-1 can include a seventh-a-first transistor T7a-1, an eighth-a-first transistor T8a-1, and a second-a-first capacitor C2a-1.

A seventh-a-first transistor T7a-1 is turned on according to the voltage of the first-first control node Q1(n) and outputs the carry clock signal CCLK2 to the output node OUT1. The seventh-a-first transistor T7a-1 includes a gate electrode connected to the first-first control node Q1(n), a first electrode to which the carry clock signal CCLK2 is applied, and a second electrode connected to the output node OUT1.

An eighth-a-first transistor T8a-1 is turned on according to the voltage of the first-second control node Qb1(n) and outputs the high potential voltage VGH to the output node OUT1. The eighth-a-first transistor T8a-1 includes a gate electrode connected to the first-second control node Qb1(n), a first electrode connected to the output node OUT1, and a second electrode connected to the first-a power line PL1a.

A second-a-first capacitor C2a-1 is connected between the gate electrode and the second electrode of the seventh-a-first transistor T7a-1.

The second output circuit 60b-1 can include a second-first control node (hereinafter referred to as a “Q2(n) node”) at which an output voltage is pulled up, a second-second control node (hereinafter referred to as a “Qb2(n) node”) at which the output voltage is pulled down, a third circuit part 61b-1, and a fourth circuit part 63b-1.

The third circuit part 61b-1 serves to control the charge and discharge of the second-first control node Q2(n) and the second-second control node Qb2(n). The third circuit part 61b-1 can include a first-b-first transistor T1b-1, a second-b-first transistor T2b-1, a third-b-first transistor T3b-1, a fourth-b-first transistor T4b-1, a fifth-b-first transistor T5b-1, a sixth-b-first transistor T6b-1, and a first-b-first capacitor C1b-1.

A first-b-first transistor T1b-1 is turned on according to a scan clock signal SCLK2 and applies the carry signal COUT(n) to a second-b-first node 2b-1. The first-b-first transistor T1b-1 includes a gate electrode to which the scan clock signal SCLK2 is applied, a first electrode connected to the output node OUT1, and a second electrode connected to the second-b-first node 2b-1.

A second-b-first transistor T2b-1 is turned on according to a scan clock signal SCLK1 and connects a third-b-first node 3b-1 to the second-b-first node 2b-1. The second-b-first transistor T2b-1 includes a gate electrode to which the scan clock signal SCLK1 is applied, a first electrode connected to the second-b-first node 2b-1, and a second electrode connected to the third-b-first transistor T3b-1.

The third-b-first transistor T3b-1 is turned on according to the voltage of the second-second control node Qb2(n) and connects the first-b power line PL1b, to which the high potential voltage VGH is applied, to a third-b-first node 3b-1. The third-b-first transistor T3b-1 includes a gate electrode connected to the second-second control node Qb2(n), a first electrode connected to the third-b-1 node 3b-1, and a second electrode connected to the first-b power line PL1b.

The fourth-b-first transistor T4b-1 is turned on according to the scan clock signal SCLK2 and applies the low potential voltage VGL to the second-second control node Qb2(n). The fourth-b-first transistor T4b-1 includes a gate electrode to which the scan clock signal SCLK2 is applied, a first electrode connected to the second-b power line PL2b to which the low potential voltage VGL is applied, and a second electrode connected to the second-second control node Qb2(n).

A fifth-b-first transistor T5b-1 is turned on according to the voltage of the second-b-first node 2b-1 and connects the first-b-first node 1b-1 and the second-second control node Qb2(n). The fifth-b-first transistor T5b includes a gate electrode connected to the second-b-first node 2b-1, a first electrode connected to the first-b-first node 1b-1, and a second electrode connected to the second-second control node Qb2(n).

A sixth-b-first transistor T6b-1 is turned on according to the low potential voltage VGL and connects the second-b-first node 2b-1 to the second-first control node Q2(n). The sixth-b-first transistor T6b-1 includes a gate electrode to which the low potential voltage VGL is applied, a first electrode connected to the second-b-first node 2b-1, and a second electrode connected to the second-first node Q2(n).

A first-b-first capacitor Clb-1 is connected between the second-second control node Qb2(n) and the first-b power line PL1b.

The fourth circuit part 63b-1 can output a scan signal SCAN(n) to an output node OUT2 based on the potentials of the second-first control node Q2(n) and the second-second control node Qb2(n). Here, the scan signal SCAN(n) can be output to the output node OUT2. The fourth circuit part 63b-1 can include a seventh-b-first transistor T7b-1, an eighth-b-first transistor T8b-1, and a second-b-first capacitor C2b-1.

A seventh-b-first transistor T7b-1 is turned on according to the voltage of the second-first control node Q2(n) and outputs the scan clock signal SCLK1 to the output node OUT2. The seventh-b-first transistor T7b-1 includes a gate electrode connected to the second-first control node Q2(n), a first electrode to which the scan clock signal SCLK1 is applied, and a second electrode connected to the output node OUT2.

An eighth-b-first transistor T8b-1 is turned on according to the voltage of the second-second control node Qb2(n) and outputs the high potential voltage VGH to the output node OUT2. The eighth-b-first transistor T8b includes a gate electrode connected to the second-second control node Qb2(n), a first electrode connected to the output node OUT2, and a second electrode connected to the first-b power line PL1b.

A second-b-first capacitor C2b-1 is connected between the gate electrode and the second electrode of the seventh-b-first transistor T7b-1.

The gate driver according to the embodiment can perform the frame skip by the clock signals CCLK1, CCLK2, SCLK1 and SCLK2.

If no frame skip is performed as shown in FIG. 20, the scan clock signal SCLK1 is not modulated during a third period P3, and thus the scan signal SCAN(n) is output at a low level from the second output circuit 60b-1.

Referring to FIG. 20 and FIGS. 21A to 21D, the gate driver according to the embodiment can operate with driving waveforms divided into a first period P1, a second period P2, a third period P3, and a fourth period P4. The bold lines indicate that the gate-on voltage is applied during each period.

In the first period P1, in the first output circuit 60a-1 of the gate driver, the carry clock signal CCLK1 can be applied at a low level and the carry clock signal CCLK2 can be applied at a high level, so that the carry signal COUT(n) can be output at a high level, and in the second output circuit 60b-1 of the gate driver, the scan clock signal CLK1 can be applied at a low level and the scan clock signal SCLK2 can be applied at a high level, so that the scan signal SCAN(n) can be output at a high level.

In the second period P2, in the first output circuit 60a-1 of the gate driver, the carry clock signal CCLK1 can be applied at a high level and the carry clock signal CCLK2 can be applied at a low level so that the carry signal COUT(n) can be output at a low level, and in the second output circuit 60b-1 of the gate driver, the scan clock signal SCLK1 can be applied at a high level and the scan clock signal SCLK2 can be applied at a low level so that the scan signal SCAN(n) can be output at a high level.

In the third period P3, in the first output circuit 60a-1 of the gate driver, the carry clock signal CCLK1 is applied at a low level and the carry clock signal CCLK2 is applied at a high level so that the carry signal COUT(n) is output at a high level, and in the second output circuit 60b-1 of the gate driver, the scan clock signal SCLK1 can be applied at a low level and the scan clock signal SCLK2 can be applied at a high level so that the scan signal SCAN(n) can be output at a low level.

In the fourth period P4, in the first output circuit 60a-1 of the gate driver, the carry clock signal CCLK1 can be applied at a high level and the carry clock signal CCLK2 can be applied at a low level so that the carry signal COUT(n) can be output at a high level, and in the second output circuit 60b-1 of the gate driver, the scan clock signal SCLK1 can be applied at a high level and the scan clock signal SCLK2 can be applied at a low level so that the scan signal SCAN(n) can be output at a high level.

When the frame skip is performed as shown in FIG. 22, the scan clock signal SCLK1 is modulated from a low level indicated by the dotted line to a high level indicated by the solid line during a third period P3, and thus the scan signal SCAN(n) is output at a high level from the second output circuit 60b-1.

Accordingly, since the first scan signal and the second scan signal are applied at low levels from the gate driver to the pixel circuit of FIG. 16, the first-first switch element and the fifth-first switch element are turned off.

The clock signals CCLK1 and SCLK1 is modulated during the frame skip period, causing the scan signal to be output at a low level; and therefore the data driver does not apply a data voltage.

Referring to FIG. 22 and FIGS. 23A to 23D, the gate driver according to the embodiment can operate with driving waveforms divided into a first period P1′, a second period P2′, a third period P3′, and a fourth period P4′. The bold lines indicate that the gate-on voltage is applied during each period.

In the first period P1′, in the first output circuit 60a-1 of the gate driver, the carry clock signal CCLK1 can be applied at a low level and the carry clock signal CCLK2 can be applied at a high level, so that the carry signal COUT(n) can be output at a high level, and in the second output circuit 60b of the gate driver, the scan clock signal SCLK1 can be applied at a low level and the scan clock signal SCLK2 can be applied at a high level, so that the scan signal SCAN(n) can be output at a high level.

In the second period P2′, in the first output circuit 60a-1 of the gate driver, the carry clock signal CCLK1 can be applied at a high level and the carry clock signal CCLK2 can be applied at a low level, so that the carry signal COUT(n) can be output at a low level, and in the second output circuit 60b-1 of the gate driver, the scan clock signal SCLK1 can be applied at a high level and the scan clock signal SCLK2 can be applied at a low level, so that the scan signal SCAN(n) can be output at a high level.

In the third period P3′, in the first output circuit 60a-1 of the gate driver, the carry clock signal CCLK1 can be modulated at a low level and the carry clock signal CCLK2 is applied at a high level, so that the carry signal COUT(n) can be output at a high level, and in the second output circuit 60b-1 of the gate driver, the scan clock signal SCLK1 can be modulated to a high level and the scan clock signal SCLK2 can be applied at a high level, so that the scan signal SCAN(n) can be output at a high level, not at a low level.

In the fourth period P4′, in the first output circuit 60a-1 of the gate driver, the carry clock signal CCLK1 can be applied at a high level and the carry clock signal CCLK2 can be applied at a low level, so that the carry signal COUT(n) can be output at a high level, and in the second output circuit 60b-1 of the gate driver, the scan clock signal SCLK1 can be applied at a high level and the scan clock signal SCLK2 can be applied at a low level, so that the scan signal SCAN(n) can be output at a high level.

During the first to fourth periods P1′ to P4′, the scan signal can be output at the high level from the gate driver.

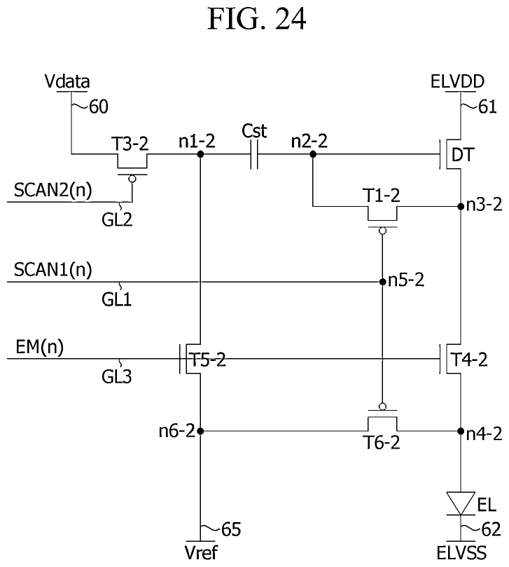

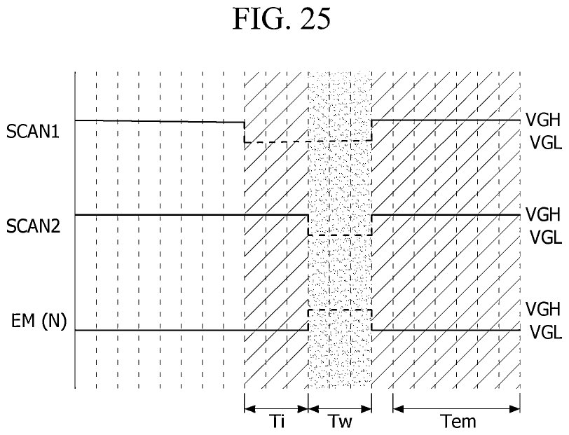

FIG. 24 is a diagram showing a pixel circuit according to a third embodiment of the present disclosure, and FIG. 25 is a diagram illustrating driving timings of the pixel circuit shown in FIG. 24.

Referring to FIGS. 24 and 25, a pixel circuit according to a third embodiment of the present disclosure includes a light-emitting element EL, a driving element DT for supplying a current to the light-emitting element EL, a plurality of switch elements T1-2, T3-2, T4-2, T5-2, and T6-2 for switching a current path connected to the driving element DT, and a first capacitor Cst for storing a gate-source voltage of the driving element DT. The driving element DT and the switch elements T1-2, T3-2, T4-2, T5-2, and T6-2 can be implemented as a P-channel oxide TFTs.

The gate signals applied to this pixel circuit include a first scan signal SCAN1(n), a second scan signal SCAN2(n), and an EM signal EM(n). Here, N is a natural number.

The capacitor Cst is connected between a first-second node n1-2 and a second-second node n2-2. The first-second node n1-2 is connected to a first electrode of a third-second switch element T3-2, a first electrode of a fifth-second switch element T5-2, and a first electrode of the capacitor Cst. The second-second node n2-2 is connected to a second electrode of the capacitor Cst, a gate electrode of the driving element DT, and a first electrode of a first-second switch element T1-2.

A first-second switch element T1-2 is turned on according to a gate-on voltage VGL of the first scan signal SCAN1(n) to connect a gate electrode and a second electrode of the driving element DT. The first-second switch element T1-2 includes a gate electrode connected to a first scan line GL1, the first electrode connected to the second-second node n2-2, and a second electrode connected to a third-second node n3-2. The first scan signal SCAN1(n) is applied to the pixels via the first scan line GL1. The third-second node n3-2 is connected to the second electrode of the driving element DT, the second electrode of the first-second switch element T1-2, and a first electrode of a fourth-second switch element T4-2.

A third-second switch element T3-2 is turned on according to a gate-on voltage VGL of a second scan signal SCAN2(n) to apply a data voltage Vdata to the first-second node n1-2. The third-second switch element T3-2 includes a gate electrode connected to a second scan line GL2, a first electrode connected to the data line 60, and a second electrode connected to the first-second node n1-2.

The fourth-second switch element T4-2 is turned on according to a gate-on voltage VGL of the EM signal EM(n) to connect the second electrode of the driving element DT to an anode electrode of the light-emitting element EL. A gate electrode of the fourth-second switch element T4-2 is connected to the EM line GL3. The first electrode of the fourth-second switch element T4-2 is connected to the third-second node n3-2, and a second electrode of the fourth-second switch element T4-2 is connected to a fourth-second node n4-2. The fourth-second node n4-2 is connected to the anode electrode of the light-emitting element EL, the second electrode of the fourth-second switch element T4-2, and the second electrode of the sixth-second switch element T6-2.

The fifth-second switch element T5-2 is turned on according to a gate-on voltage VGL of the EM signal EM(n) to connect the first-second node n1-2 to a Vref wire 65. The fifth-second switch element T5-2 includes a gate electrode connected to the EM line GL3, the first electrode connected to the first-second node n1-2, and a second electrode connected to the Vref wire 65. A reference voltage Vref is supplied to the pixels via the Vref wire 65.

The sixth-second switch element T6-2 is turned on according to a gate-on voltage VGL of the first scan signal SCAN1(n) to connect a Vref wire 65 to the anode electrode of the light-emitting element EL. The sixth-second switch element T6-2 includes a gate electrode connected to a first scan line GL1, the first electrode connected to the Vref wire 65, and a second electrode connected to the fourth-second node n4-2.

In an initialization stage Ti, a first-second switch elements T1-2, a fourth-second switch element T4-2, the fifth-second switch element T5-2, and a sixth-second switch element T6-2 are turned on, so that the voltages of a first-second nodes n1-2 and a fourth-second nodes n4-2 are discharged to a reference voltage Vref.

In a data writing stage Tw, the first-second switch element T1-2, a third-second switch element T3-2, and the sixth-first switch element T6-2 are turned on, so that the data voltage is applied to the first-second node n1-2 and the voltage of the second-second node n2-2 becomes a voltage of Vref−Vdata+ELVDD+Vth. The threshold voltage Vth of the driving element is sensed and charged to a capacitor Cst connected to the second-second node n2-2.

In a light emission stage Tem, the fourth-second switch element T4-2 and the fifth-second switch element T5-2 are turned on, so that a current flows to the light-emitting element EL through the driving element DT to emit the light-emitting element EL.

Since the way of implementing the frame skip is not to output the gate signal, it can be possible to implement it by not outputting three signals, such as all of the first and second scan signals and the EM signal, to the pixel circuit of FIG. 24. For example, the first-second switch element T1-2, the third-second switch element T3-2, and the sixth-second switch element T6-2 are turned off so as not to initialize the voltages of the second-second node n2-2 and a third-second node n3-2 during the frame skipping.

In this case, the gate driver outputting the first and second scan signals can be implemented as the circuit of FIG. 19, and the gate driver outputting the EM signal can be implemented as the circuit of FIG. 11.

Depending on how the pixel circuit is constructed and which PMOS/NMOS transistors are used, it can be necessary to use the circuit in FIG. 11, the circuit in FIG. 19, or both FIGS. 11 and 19 for the gate driver. Because the gate drivers of all current display devices can be made in a combination of FIGS. 11 and 19, the use of the gate drivers proposed by the present disclosure can enable the frame skip to be performed regardless of how the pixel circuit is constructed and which PMOS/NMOS transistors are used.

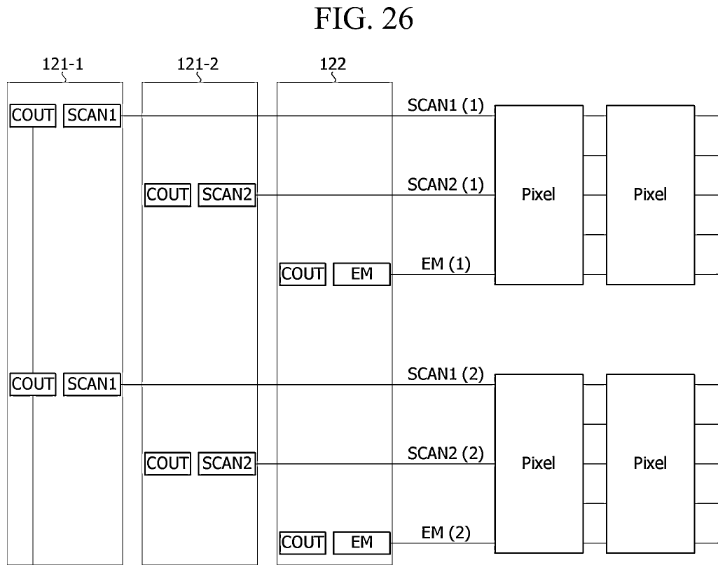

FIG. 26 is a diagram showing a gate driver that applies a gate signal to the pixel circuit shown in FIG. 24.

Referring to FIG. 26, the gate driver according to the embodiment can include a first scan driver 121-1, a second scan driver 121-2 and an EM driver 122. In order not to output all of the first and second scan signals and the EM signal to the pixel circuit of FIG. 24 during frame skipping, the first scan driver 121-1 and the second scan driver 121-2 are configured as shown in FIG. 19, and the EM driver 122 is configured as shown in FIG. 11.

For example, in the first scan driver 121-1 and the second scan driver 121-2, and the EM driver 122, as shown in FIG. 8, a signal transmission part for outputting a carry signal COUT and a signal transmission part for outputting a first scan signal SCAN1, a signal transmission part for outputting a second scan signal SCAN2, or a signal transmission part for outputting the EM signal EM can be configured separately.

In another embodiment of the present disclosure, the signal transmission parts constituting the gate driver can be configured to have two output circuits, i.e., a first output circuit and a second output circuit, wherein the first output circuit is configured to output a carry signal and the second output circuit is configured to output a gate signal, and wherein the clock lines CL1 and CL2 from which clock signals are applied to the first output circuit and the clock lines CL3 and CL4 from which clock signals are applied to the second output circuit can be separated for independent use.

More specifically, when the first output circuit and the second output circuit share the clock lines that apply the clock signals to the first output circuit and the second output circuit, the carry signal can be deformed and output before or after the time of modulating the clock signal, and the gate signal can be deformed and output by the deformed carry signal. Here, transforming the carry signal means that instead of outputting a carry signal of 2 horizontal periods (2H) corresponding to a start pulse of 2H, a carry signal of 3H or more is output.

To do this, an embodiment separates the clock lines into a clock line that provides a clock signal to the first output circuit and a clock line that provides a clock signal to the second output circuit.

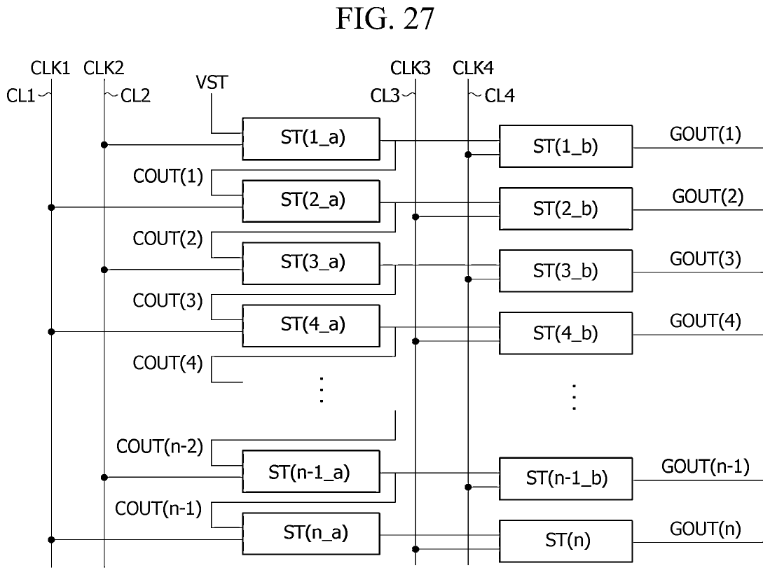

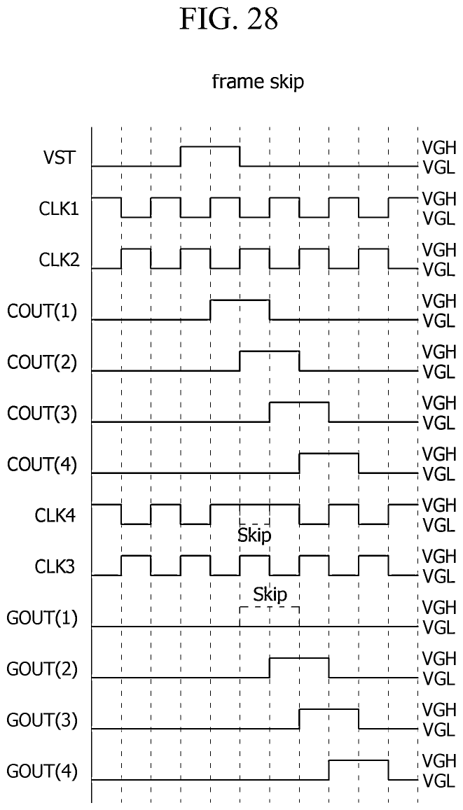

FIG. 27 is a diagram showing a shift register in a gate driver according to an embodiment, and FIG. 28 is a diagram illustrating driving waveforms of the gate driver shown in FIG. 27.

Referring to FIGS. 27 and 28, the gate driver according to an embodiment includes a plurality of signal transmission parts (ST(1_a), ST(1_b)),(ST(2_a), ST(2_b)),(ST(3_a), ST(3_b)), (ST(4_a), ST(4_b)), . . . ,(ST(n-1_a), ST(n-1_b)),(ST(n_a), ST(n_b)) connected in cascade via carry lines through which carry signals are transmitted.

In the embodiment, a pair of the output circuits in the respective signal transmission parts can be implemented as the same circuit, but are not necessarily limited thereto, and can be implemented as different circuits.

Each of the first output circuits ST(1_a), ST(2_a), ST(3_a), ST(4_a), . . . , ST(n-1_a), ST(n_a) among the signal transmission parts receives a start pulse VST or a carry signal output from its preceding signal transmission part and a clock signal. A first output circuit ST(1_a) starts to drive according to the start pulse VST, and the other output circuits ST(2_a), ST(3_a), ST(4_a), . . . , ST(n-1_a), and ST(n_a) start to drive by receiving carry signals COUT(1), COUT(2), COUT(3), COUT(4), . . . , COUT(n-2), and COUT(n-1) from their preceding signal transmission parts.

In this case, a first clock line CL1 to which the first clock signal CLK1 is applied and a second clock line CL2 to which the second clock signal CLK2 is applied can be connected to first output circuits ST(1_a), ST(2_a), ST(3_a), ST(4_a), . . . , ST(n-1_a), and ST(n_a).

Among the first output circuits ST(1_a), ST(2_a), ST(3_a), ST(4_a), . . . , ST(n-1_a), and ST(n_a), odd-numbered first output circuits ST(1_a), ST(3_a), . . . , and ST(n-1_a) can be connected to the second clock line CL2 and receive the second clock signal CLK2 from the second clock line CL2, and even-numbered first output circuit ST(2_a), ST(4_a), . . . , and ST(n_a) can be connected to the first clock line CL1 and receive the first clock signal CLK1 from the first clock line CL1. The first and second clock signals can have opposite phases to each other.

Each of the second output circuits ST(1_b), ST(2_b), ST(3_b), ST(4_b), . . . , ST(n-1_b), ST(n_b) shift the start pulse VST or the carry signals COUT(1), COUT(2), COUT(3), COUT(4), . . . , COUT(n-2), and COUT(n-1) output from their preceding signal transmission parts in synchronization with the timing of the clock signal to sequentially output the gate signals GOUT(1), GOUT(2), GOUT(3), GOUT(4), . . . , GOUT(n-1), GOUT(n), respectively.

In addition, a third clock line CL3 to which a third clock signal CLK3 is applied and a fourth second clock line CL4 to which a fourth clock signal CLK4 is applied can be connected to second output circuits ST(1_b), ST(2_b), ST(3_b), ST(4_b), . . . , ST(n-1_b), and ST(n_b).

Among the second output circuits ST(1_b), ST(2_b), ST(3_b), ST(4_b), . . . , ST(n-1_b), and ST(n_b), odd-numbered second output circuits ST(1_b), ST(3_b), . . . , and ST(n-1_b) can be connected to the fourth clock line CL4 and receive the fourth clock signal CLK4 from the fourth clock line CL4, and even-numbered second output circuits ST(2_b), ST(4_b), . . . , and ST(n_b) can be connected to the third clock line CL3 and receive the third clock signal CLK3 from the third clock line CL3. The third and fourth clock signals can have opposite phases to each other, wherein the third clock signal have the same phase as the second clock signal, and the fourth clock signal can have the same phase as the first clock signal.

The second clock signal CLK2 can be applied to the first output circuits that output odd-numbered gate signals, and the fourth clock signal CLK4 can be applied to the second output circuits that output odd-numbered gate signals; and the first clock signal CLK1 can be applied to the first output circuits that output even-numbered gate signals, and the third clock signal CLK3 can be applied to the second output circuits that output even-numbered gate signals. In other words, the first clock signal and the second clock signal having different phases can be alternately applied to the first output circuits that output the gate signals, and the third clock signal and the fourth clock signal having different phases can be alternately applied to the second output circuits that output the gate signals.

In this case, during the frame skip period as shown in FIG. 28, the clock signals applied to the second output circuits that output the gate signal are modulated so as not to output the gate signal regardless of the first output circuits that output the carry signal. For example, although the carry signal can be still output, the gate signal can be selectively output by modulating the clock signals.

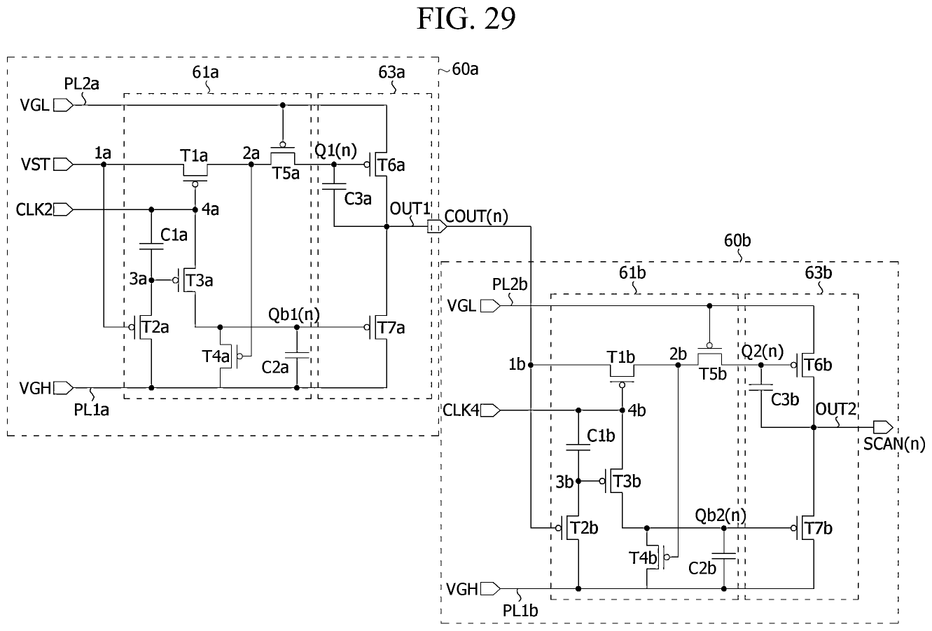

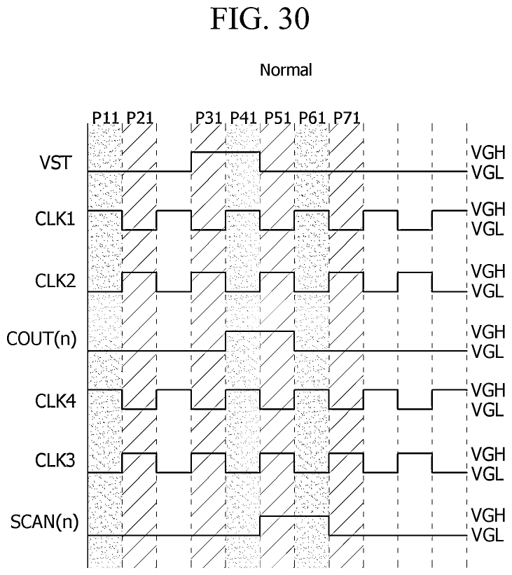

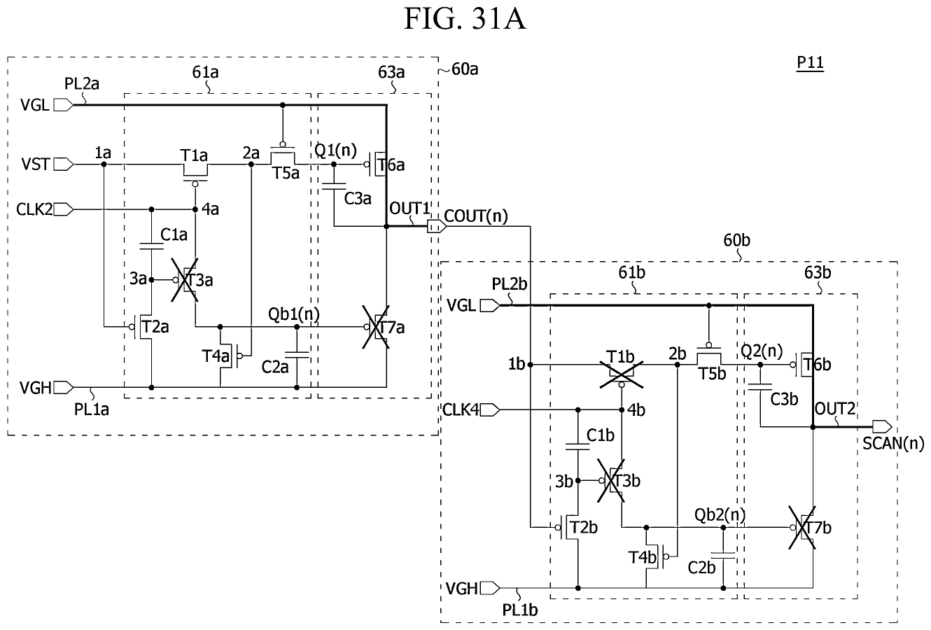

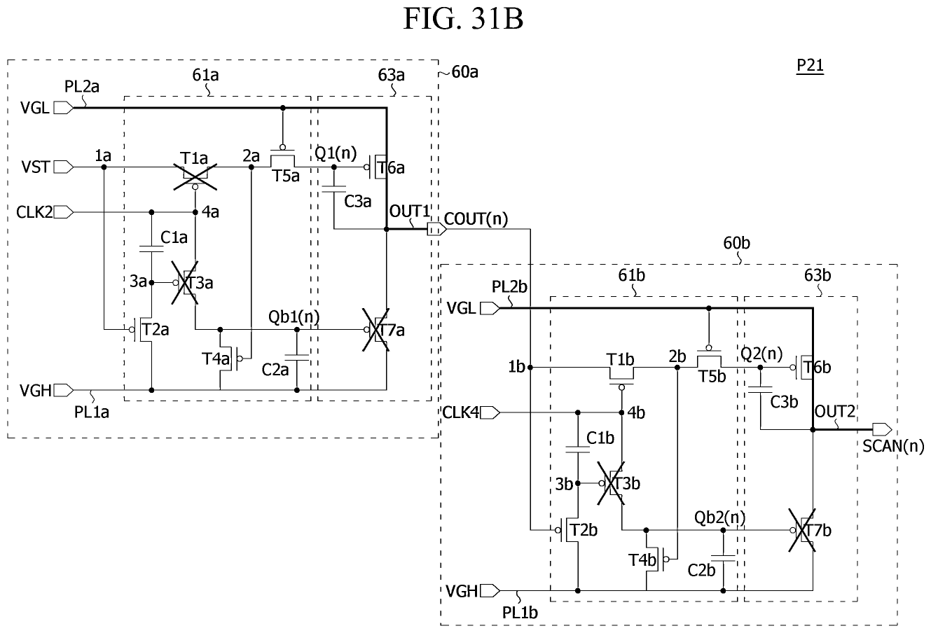

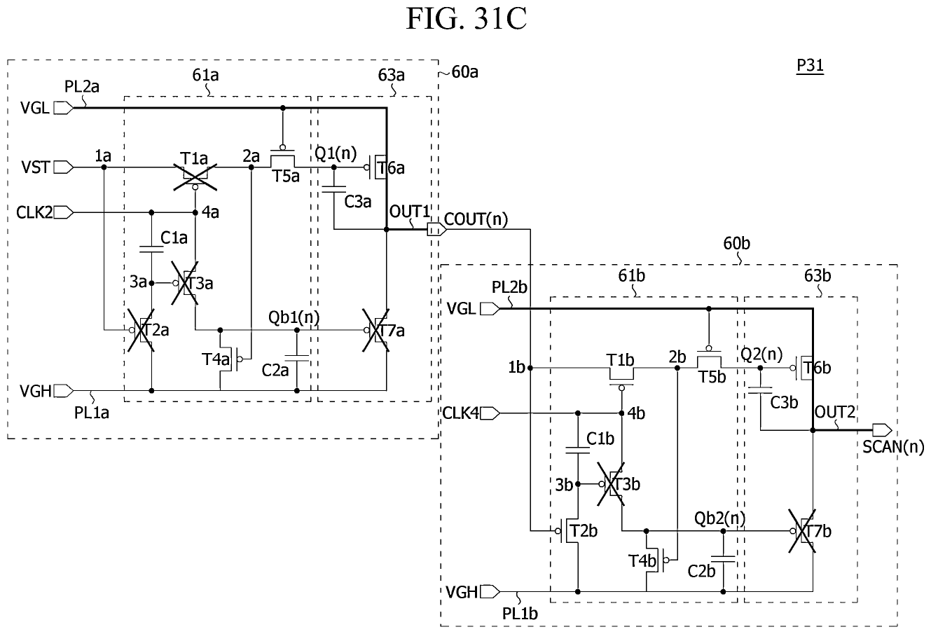

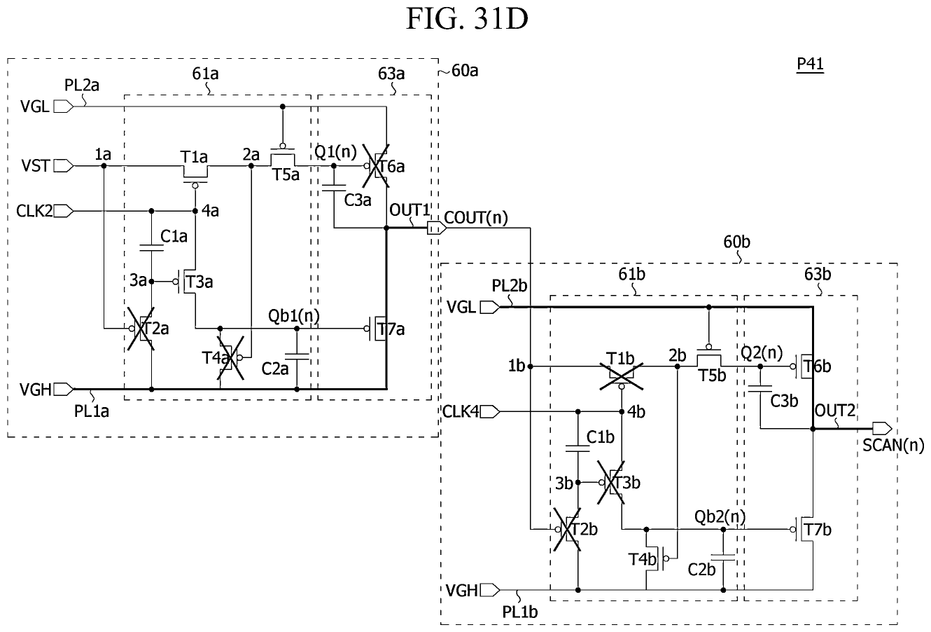

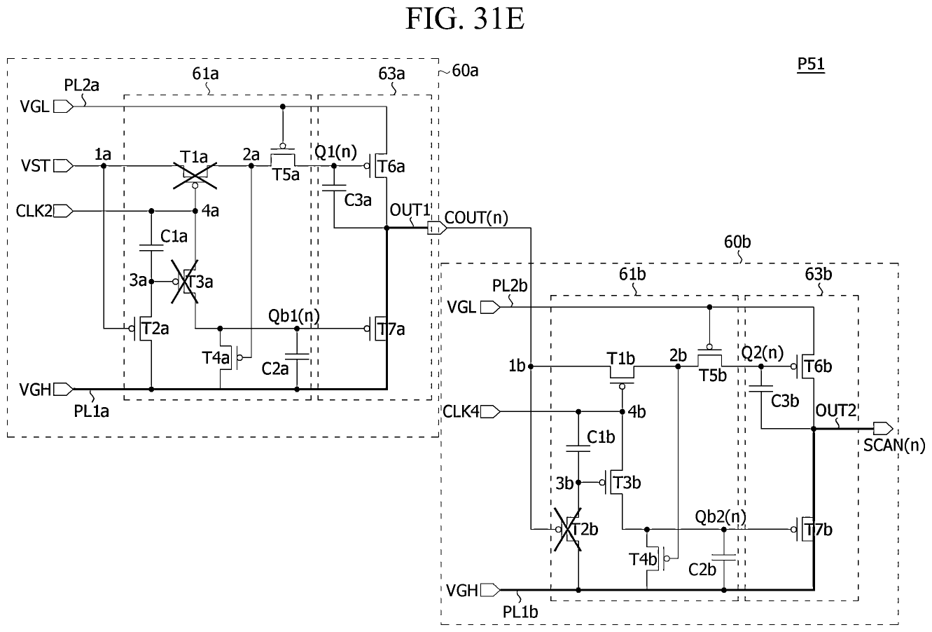

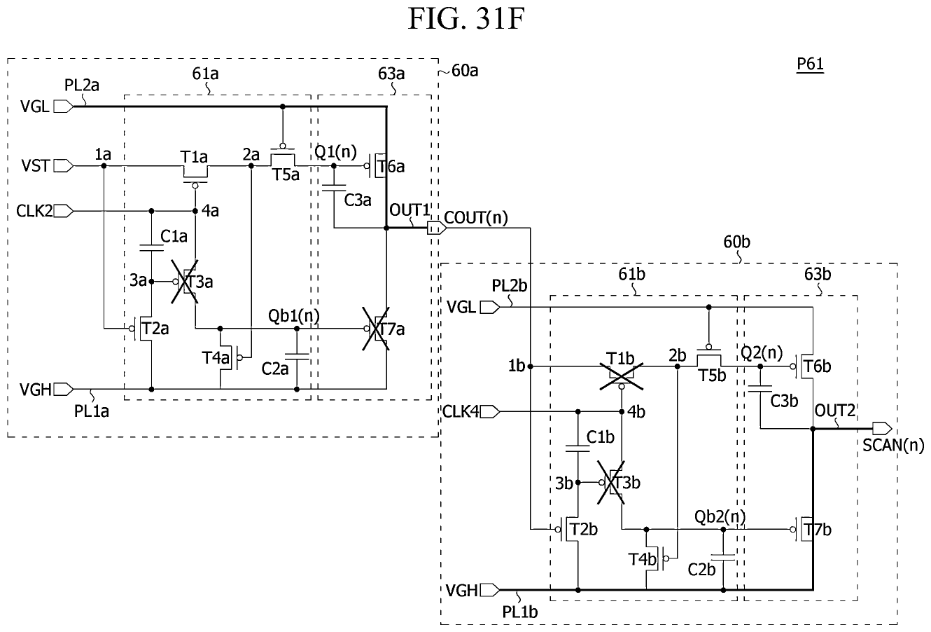

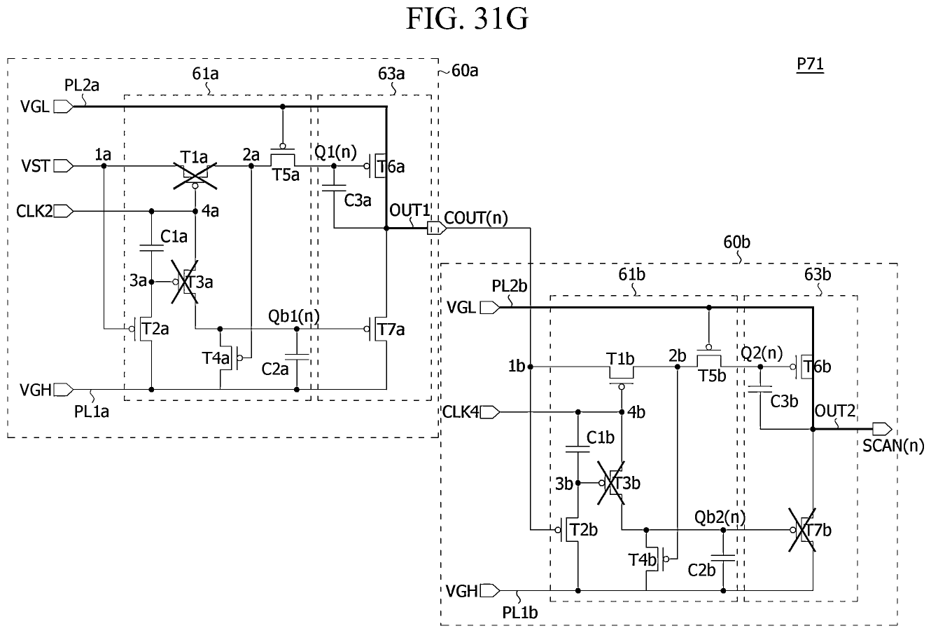

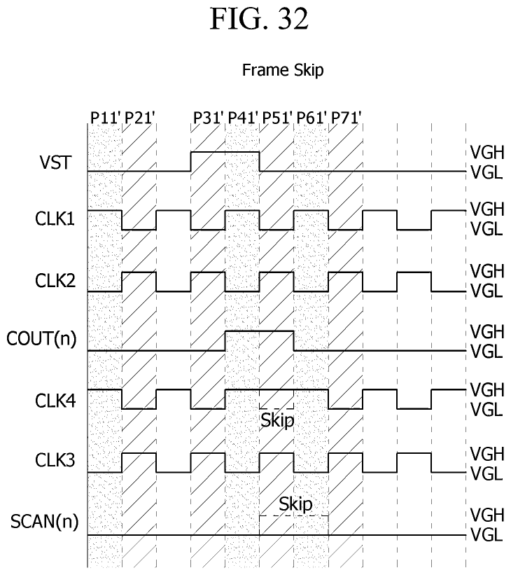

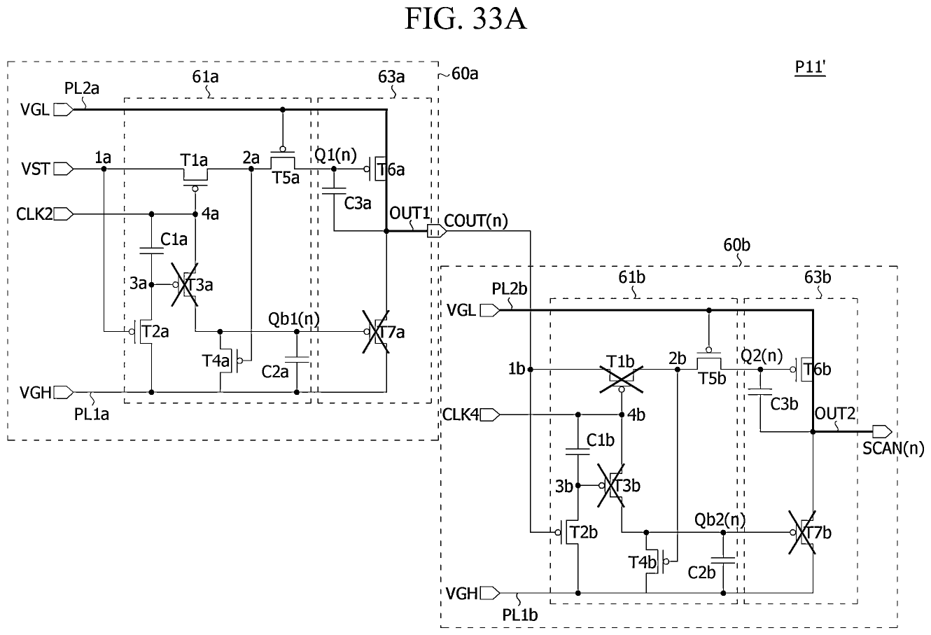

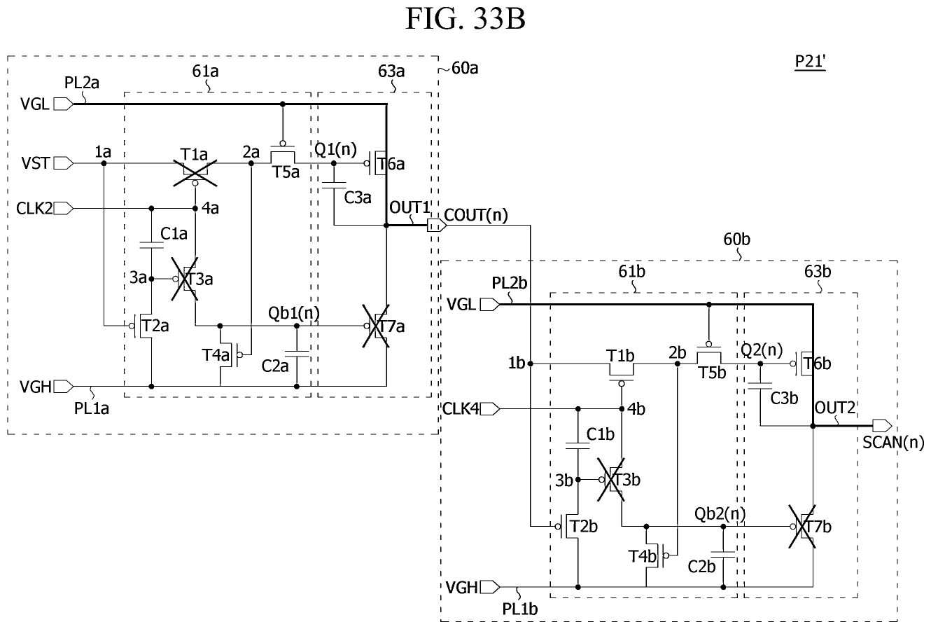

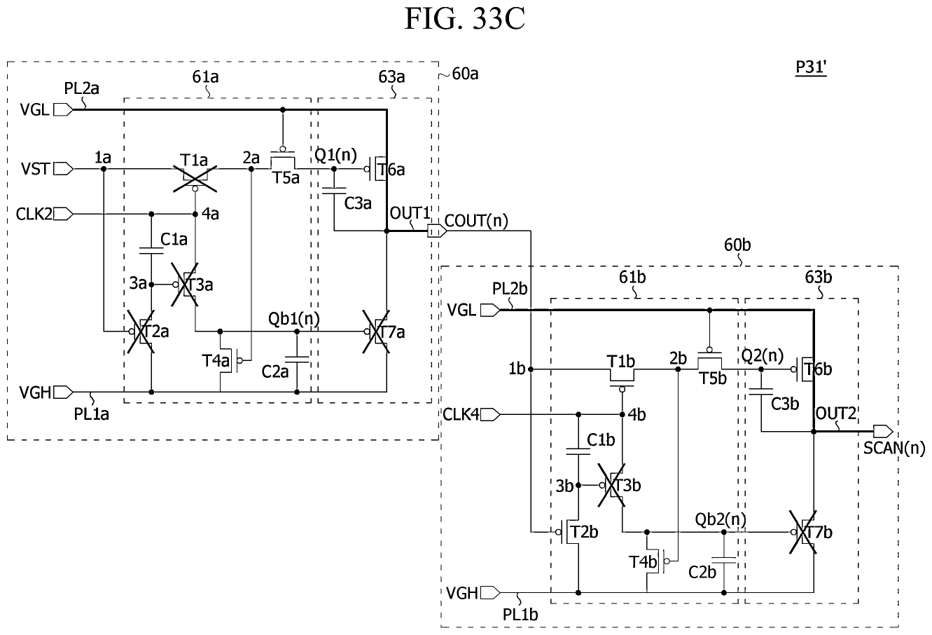

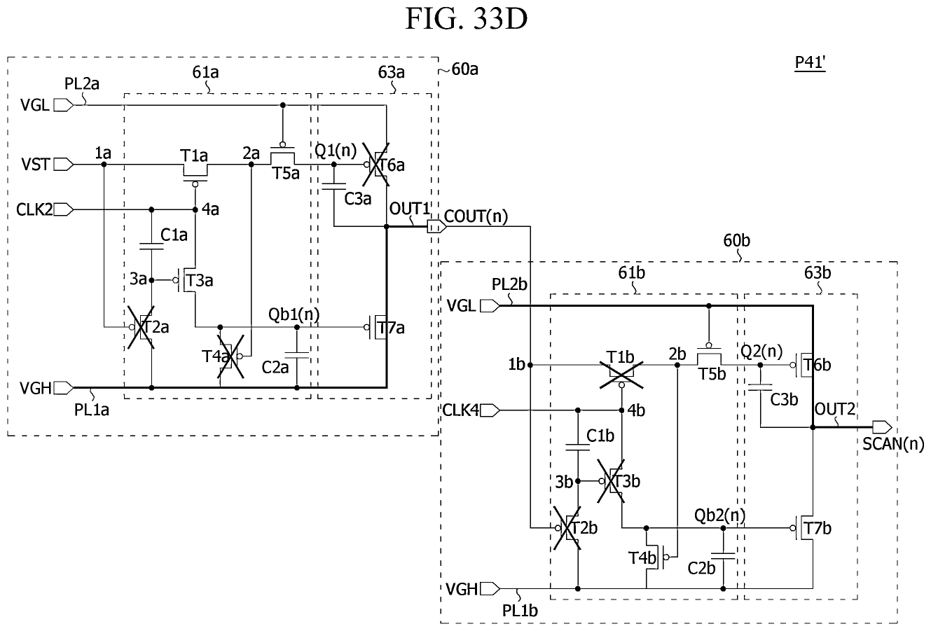

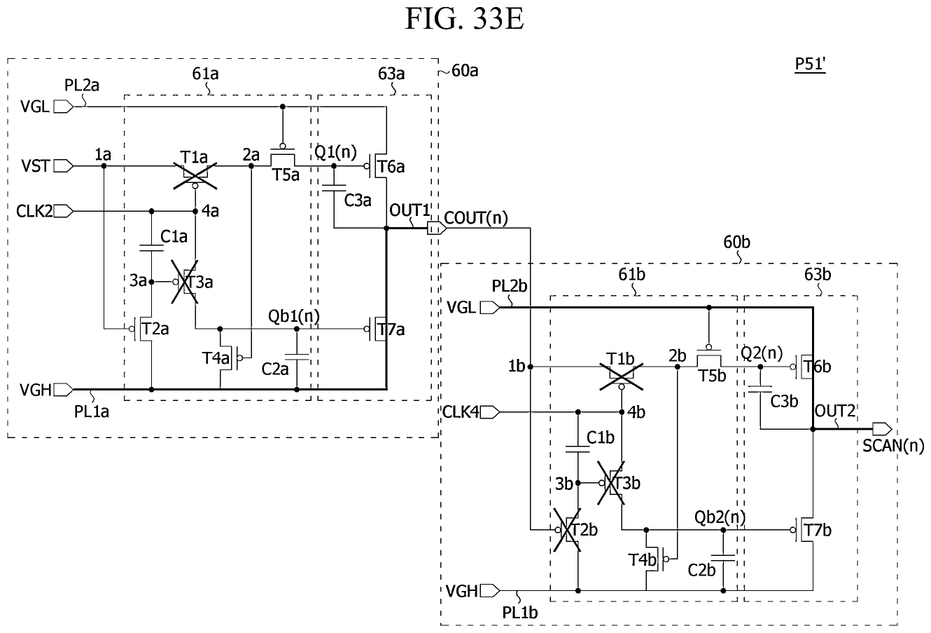

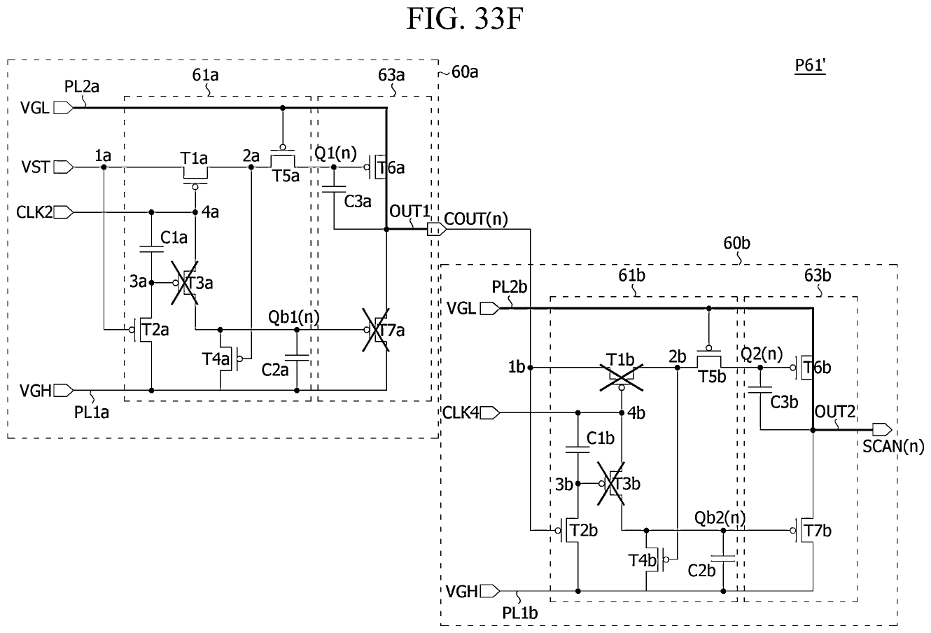

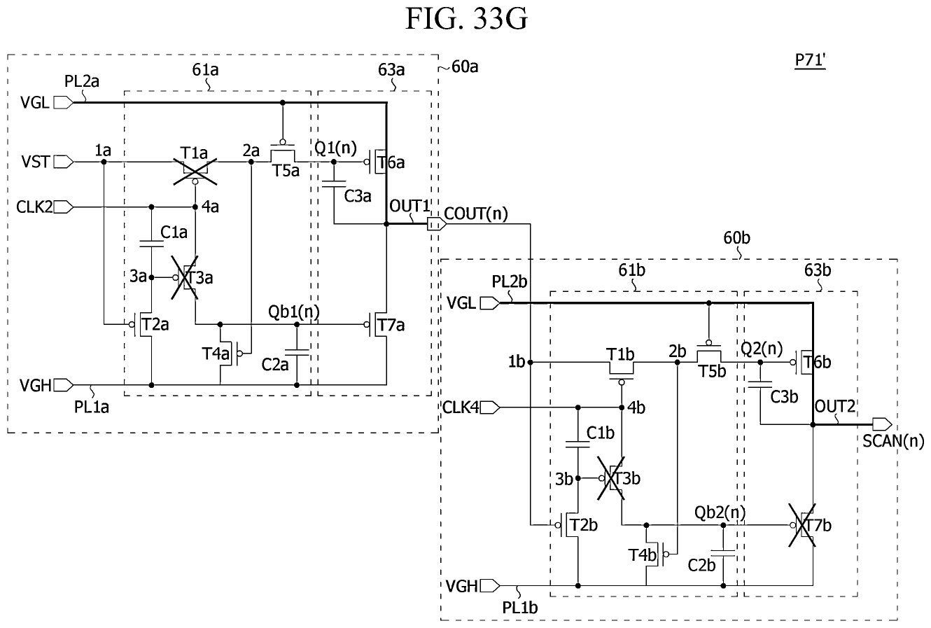

FIG. 29 is a diagram illustrating a gate driver according to a third embodiment, FIG. 30 is a diagram illustrating driving waveforms during a normal driving in the gate driver shown in FIG. 29, FIGS. 31A to 31G are diagrams illustrating an operating principle of the gate driver by way of the driving waveforms shown in FIG. 30, FIG. 32 is a diagram illustrating driving waveform during a frame skipping in the gate driver shown in FIG. 29, and FIGS. 33A to 33G are diagrams illustrating an operating principle of the gate driver by way of the driving waveforms shown in FIG. 32.

Referring to FIG. 29, a gate driver according to a third embodiment of the present disclosure can include a first output circuit 60a from which a carry signal is output, and a second output circuit 60b from which a scan signal is output.

The configuration of a first output circuit 60a and a second output circuit 60b is identical to the configuration and operating principle of the output circuits shown in FIG. 11, and therefore a description thereof is omitted. However, because the clock signals applied to the second output circuit 60b are different, only a configuration in which the clock signals are applied will be described.

The third circuit part 61b can include a first-b transistor T1b, a second-b transistor T2b, a third-b transistor T3b, a fourth-b transistor T4b, a fifth-b transistor T5b, and a first-b capacitor C1b.

The first-b transistor T1b is turned on according to a clock signal CLK4 and connects a first-b node 1b to a second-b node 2b. The first-b transistor T1b includes a gate electrode to which the clock signal CLK4 is applied, a first electrode connected to the first-b node 1b, and a second electrode connected to the second-b node 2b.

The second-b transistor T2b is turned on according to the carry signal COUT(n), and connects a third-b node 3b to a first-b power line PL1b to which the high potential voltage VGH is applied. The second-b transistor T2b includes a gate electrode to which the carry signal COUT(n) is applied, a first electrode connected to the third-b node 3b, and a second electrode connected to the first-b power line PL1b.

The third-b transistor T3b is turned on according to the voltage of the third-b node 3b and connects a fourth-b node 4b to which the clock signal CLK4 is applied to the second-second control node Qb2(n). The third-b transistor T3b includes a gate electrode connected to the third-b node 3b, a first electrode connected to the fourth-b node 4b, and a second electrode connected to the second-second control node Qb2(n).

The fourth-b transistor T4b is turned on according to the voltage of the second-b node 2b and connects the second-second control node Qb2(n) to the first-b power line PL1b. The fourth-b transistor T4b includes a gate electrode connected to the second-b node 2b, a first electrode connected to the second-second control node Qb2(n), and a second electrode connected to the first-b power line PL1b.

The fifth-b transistor T5b is turned on according to the low potential voltage VGL, and connects the second-b node 2b to the second-first control node Q2(n). The fifth-b transistor T5b includes a gate electrode connected to the second-b power line PL2b to which the low potential voltage is applied, a first electrode connected to the second-b node 2b, and a second electrode connected to the second-first control node Q2(n).

The first-b capacitor C1b is connected between the third-b node 3b and the fourth-b node 4b, and the second-b capacitor C2b is connected between the second-second node Qb2(n) and the first-b power line PL1b.

Referring to FIG. 30 and FIGS. 31A to 31G, the gate driver according to the embodiment can operate with driving waveforms divided into an 11th period P11, a 21st period P21, a 31st period P31, a 41st period P41, a 51st period P51, a 61st period P61, and a 71st period P71.

In the 11th period P11, in the first output circuit 60a of the gate driver, the start pulse VST can be applied at a low level and the clock signal CLK2 can be applied at a low level, so that the carry signal COUT(n) can be output at a low level, and in the second output circuit 60b of the gate driver, the carry signal can be applied at a low level and the clock signal CLK4 can be applied at a high level, so that the scan signal SCAN(n) can be output at a low level.

In the 21st period P21, in the first output circuit 60a of the gate driver, the start pulse VST can be applied at a low level and the clock signal CLK2 can be applied at a high level, so that the carry signal COUT(n) can be output at a low level, and in the second output circuit 60b of the gate driver, the carry signal can be applied at a low level and the clock signal CLK4 can be applied at a low level, so that the scan signal SCAN(n) can be output at a low level.

In the 31st period P31, in the first output circuit 60a of the gate driver, the start pulse VST can be applied at a high level and the clock signal CLK2 is applied at a high level, so that the carry signal COUT(n) is output at a low level, and in the second output circuit 60b of the gate driver, the carry signal is applied at a low level and the clock signal CLK4 is applied at a low level, so that the scan signal SCAN(n) is output at a low level.

In the 41st period P41, in the first output circuit 60a of the gate driver, the start pulse VST can be applied at a high level and the clock signal CLK2 can be applied at a low level, so that the carry signal COUT(n) is output at a high level, and in the second output circuit 60b of the gate driver, the carry signal can be applied at a high level and the clock signal CLK4 can be applied at a high level, so that the scan signal SCAN(n) is output at a low level.

In the 51st period P51, in the first output circuit 60a of the gate driver, the start pulse VST can be applied at a low level and the clock signal CLK2 can be applied at a high level, so that a carry signal COUT(n) can be output at a high level, and in the second output circuit 60b of the gate driver, the carry signal can be applied at a high level and the clock signal CLK4 can be applied at a low level, so that the scan signal SCAN(n) can be output at a high level.

In the 61st period P61, in the first output circuit 60a of the gate driver, the start pulse VST can be applied at a low level and the clock signal CLK2 can be applied at a low level, so that the carry signal COUT(n) can be output at a low level, and in the second output circuit 60b of the gate driver, the carry signal can be applied at a low level and the clock signal CLK4 can be applied at a high level, so that the scan signal SCAN(n) can be output at a high level.

In the 71st period P71, in the first output circuit 60a of the gate driver, the start pulse VST can be applied at a low level and the clock signal CLK2 can applied at a high level, so that the carry signal COUT(n) can be output at a low level, and in the second output circuit 60b of the gate driver, the carry signal is applied at a low level and the clock signal CLK4 is applied at a low level, so that the scan signal SCAN(n) is output at a low level.

When the frame skip is performed, as shown in FIG. 32, the clock signal CLK4 is modulated from a low level indicated by the dotted line to a high level indicated by the solid line during the 51st period P51′, causing the scan signal SCAN(n) to be output at a low level from the second output circuit 60b.

The clock signal CLK4 is modulated during the frame skip period, causing the scan signal to be output at a low level; and therefore the data driver does not apply a data voltage.

Referring to FIG. 32 and FIGS. 33A to 33G, the gate driver according to the embodiment can operate with driving waveforms divided into an 11th period P11′, a 21st period P21′, a 31st period P31′, a 41st period P41′, a 51st period P51′, a 61st period P61′, and a 71st period P71′.

In the 11th period P11′, when the start pulse VST is at a low level, the clock signal CLK2 can be applied at a low level so that the carry signal COUT(n) can be output at a low level in the first output circuit 60a of the gate driver, and the clock signal CLK4 can be applied to at a high level so that the scan signal SCAN(n) can be output at a low level in the second output circuit 60b of the gate driver.

In the 21st period P21′, when the start pulse VST is at a low level, the clock signal CLK2 can be applied at a high level so that the carry signal COUT(n) can be output at a low level in the first output circuit 60a of the gate driver, and the clock signal CLK4 can be applied at a low level so that the scan signal SCAN(n) can be output at a low level in the second output circuit 60b of the gate driver.

In the 31st period P31′, when the start pulse VST is at a high level, the clock signal CLK2 can be applied at a high level so that the carry signal COUT(n) can be output at a low level in the first output circuit 60a of the gate driver, and the clock signal CLK4 can be applied at a low level so that the scan signal SCAN(n) can be output at a low level in the second output circuit 60b of the gate driver.

In the 41st period P41′, when the start pulse VST is at a high level, the clock signal CLK2 can be applied to a low level so that the carry signal COUT(n) can be output at a high level in the first output circuit 60a of the gate driver, and the clock signal CLK4 can be applied at a high level so that the scan signal SCAN(n) can be output at a low level in the second output circuit 60b of the gate driver.

In the 51st period P51′, when the start pulse VST is at a low level, the clock signal CLK2 can be applied at a high level so that the carry signal COUT(n) can be output at a high level in the first output circuit 60a of the gate driver, and the clock signal CLK4 can be applied at a high level not at a low level so that the scan signal SCAN(n) can be output at a low level not at a high level in the second output circuit 60b of the gate driver.

In the 61st period P61′, when the start pulse VST is at a low level, the clock signal CLK2 can be applied at a low level so that the carry signal COUT(n) can be output at a low level in the first output circuit 60a of the gate driver, and the clock signal CLK4 can be applied at a high level so that the scan signal SCAN(n) can be output at a low level in the second output circuit 60b of the gate driver.

In the 71st period P71′, when the start pulse VST is at a low level, the clock signal CLK2 can be applied at a high level so that the carry signal COUT(n) can be output at a low level in the first output circuit 60a of the gate driver, and the clock signal CLK4 can be applied at a low level so that the scan signal SCAN(n) can be output at a low level in the second output circuit 60b of the gate driver.

The clock signal applied to the second output circuit can be modulated during the 51st period so that the scan signal is output from the gate driver at a low level, not a high level, during the 51st and 61st periods.

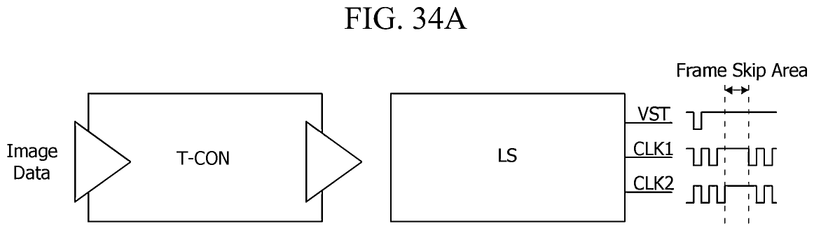

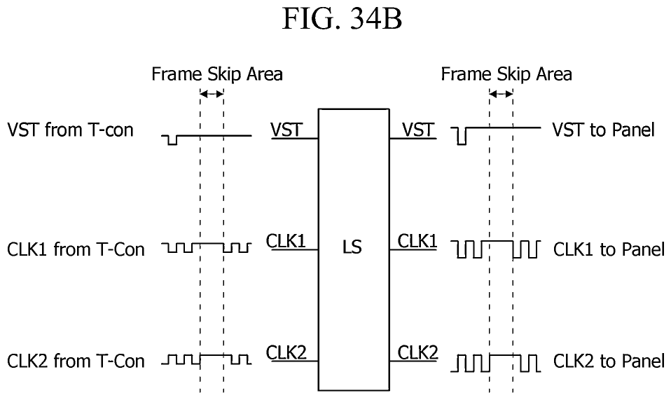

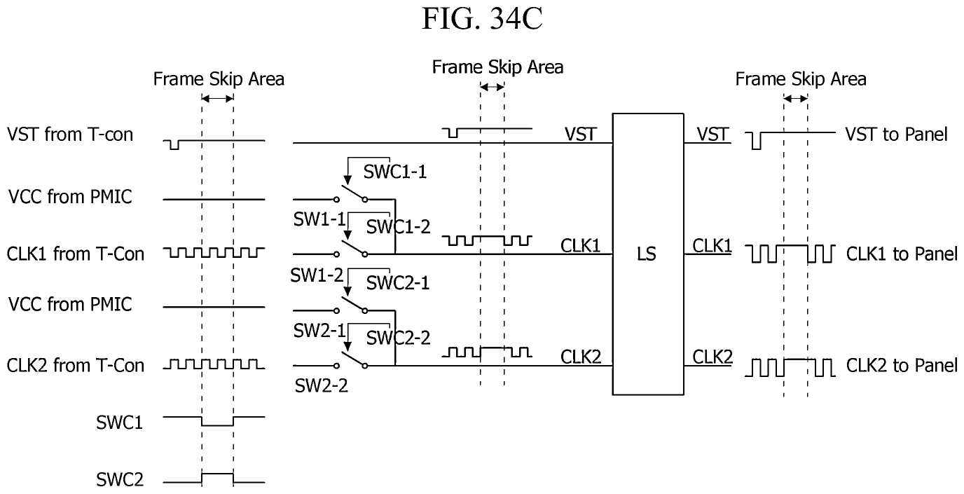

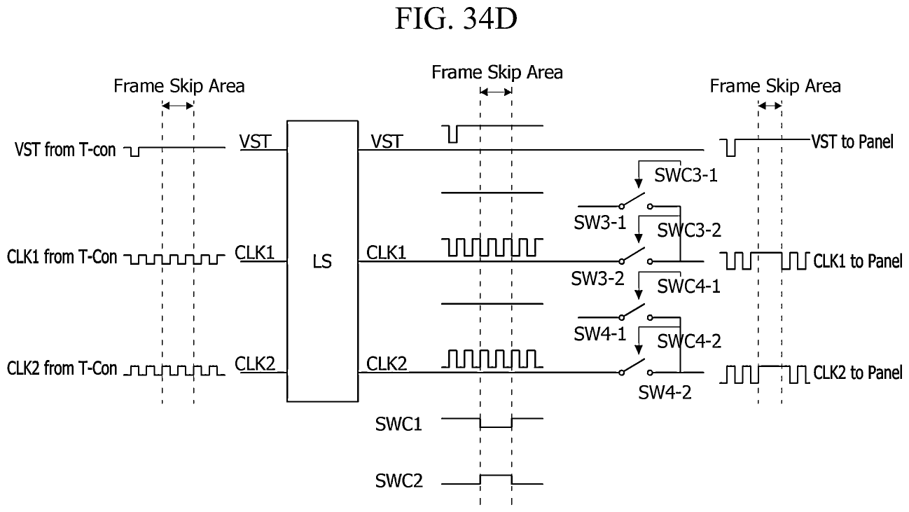

FIGS. 34A to 34D are diagrams for describing a principle of modulation of the clock signal.

Referring to FIG. 34A and FIG. 34B, an embodiment of the present disclosure can generate the clock signal using a timing controller T-CON and a level shifter LS. In other words, the timing controller T-CON generates the start signal VST and the clock signals CLK1 and CLK2 at a first voltage level and applies them to the level shifter LS. The level shifter LS generates the first voltage level of the start signal VST and the clock signals CLK1 and CLK2 as a second voltage level, i.e., the gate-on voltages VGH and VEH and the gate-off voltages VGL and VEL, and applies them to the gate driver in the display panel.

In this case, the timing controller T-CON can analyze input image data to calculate an area to skip frames, and modulate the clock signal having the first voltage level VCC on the basis of the calculated area to skip frames.

The following describes various schemes for modulating and generating the clock signal.

Referring to FIG. 34B, the timing controller T-CON modulates the clock signals having the first voltage level based on the calculated area to skip frames or corresponding to an area to skip frames during frame shipping and applies the clock signal having the modulated first voltage level to the level shifter LS.

The level shifter LS can receive the start signal VST and the modulated clock signals CLK1 and CLK2 having the first voltage level from the timing controller T-CON, and can generate the start signal VST and the clock signals CLK1 and CLK2 having the second voltage level by adjusting the voltage level of the start signal VST and the modulated clock signals CLK1 and CLK2 having the first voltage level.

Referring to FIG. 34C, a plurality of switches SW1-1, SW1-2, SW2-1, and SW2-2 are provided on lines through which the clock signals CLK1 and CLK2 are input to the level shifter LS, wherein the clock signals having the first voltage level are modulated by the plurality of switches SW1-1, SW1-2, SW2-1, and SW2-2.

A first-first switch SW1-1 and a first-second switch SW1-2 are connected in parallel to the line through which the clock signal CLK1 is applied, wherein the voltage VCC of the first voltage level generated from a power supply PMIC is applied to the first-first switch SW1-1 and the clock signal CLK1 generated by the timing controller T-CON is applied to the first-second switch SW1-2.

The first-first switch SW1-1 and the first-second switch SW1-2 are on or off according to switching control signals SWC1-1 and SWC1-2 applied from the timing controller T-CON to modulate the clock signal CLK1 having the first voltage level.

A second-first switch SW2-1 and a second-second switch SW2-2 are connected in parallel to the line through which the clock signal CLK2 is applied, wherein the voltage VCC of the first voltage level generated by the power supply PMIC is applied to the second-first switch SW2-1 and the clock signal CLK2 generated by the timing controller T-CON is applied to the second-second switch SW2-2.

The second-first switch SW2-1 and the second-second switch SW2-2 are on or off according to switching control signals SWC2-1 and SWC2-2 applied from the timing controller T-CON to modulate the clock signal CLK2 having the first voltage level.

Referring to FIG. 34D, a plurality of switches SW3-1, SW3-2, SW4-1, and SW4-2 are provided on lines through which the clock signals are output from the level shifter LS, wherein the clock signals having the second voltage level are modulated by the plurality of switches SW3-1, SW3-2, SW4-1, and SW4-2.

A third-first switch SW3-1 and a third-second switch SW3-2 are connected in parallel to the line through which the clock signal CLK1 is output, wherein the voltage VGH of the second voltage level generated by the power supply PMIC is applied to the third-first switch SW3-1 and the clock signal CLK1 having the second voltage level is output from the level shifter LS to the third-second switch SW3-2.

The third-first switch SW3-1 and the third-second switch SW3-2 are on or off according to switching control signals SWC3-1 and SWC3-2 applied from the timing controller T-CON to modulate the clock signal CLK1 having the second voltage level.

A fourth-first switch SW4-1 and a fourth-second switch SW4-2 are connected in parallel to the line through which the clock signal CLK2 is output, wherein the voltage VGH of the second voltage level generated by the power supply PMIC is applied to the fourth-first switch SW4-1 and the clock signal CLK2 is output from the level shifter LS to the fourth-second switch SW4-2.

The fourth-first switch SW4-1 and the fourth-second switch SW4-2 are on or off according to switching control signals SWC4-1 and SWC4-2 applied from the timing controller T-CON to modulate the clock signal CLK2 having the second voltage level.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A gate driver comprising:
a plurality of signal transmission parts that are connected in a cascade configuration via carry lines through which carry signals are applied from preceding signal transmission parts and are configured to output gate signals according to a clock signal,
wherein an (n)th signal transmission part includes:
a first output circuit configured to receive a start pulse or an (n-1)th carry signal from a preceding signal transmission part and the clock signal, and charge or discharge a first-first control node and a first-second control node to output an (n)th carry signal, where n is a positive integer; and
a second output circuit configured to receive the (n)th carry signal output from the first output circuit and the clock signal, and charge or discharge a second-first control node and a second-second control node to output an (n)th gate signal.

2. The gate driver of claim 1, wherein:
the clock signal includes a first clock signal applied via a first clock line and a second clock signal applied via a second clock line, the second clock signal having an opposite phase to the first clock signal;
the second clock line is connected to the first output circuit in an odd-numbered signal transmission part, and the first clock line is connected to the second output circuit in the odd-numbered signal transmission part; and
the first clock line is connected to the first output circuit in an even-numbered signal transmission part, and the second clock line is connected to the second output circuit in the even-numbered signal transmission part.

3. The gate driver of claim 1, wherein:
the clock signal includes a first clock signal applied via a first clock line, a second clock signal applied via a second clock line and having an opposite phase to the first clock signal, a third clock signal applied via a third clock line and having the same phase as the second clock signal, and a fourth clock signal applied via a fourth clock line and having the same phase as the first clock signal;
the second clock line is connected to the first output circuit in an odd-numbered signal transmission part, and the fourth clock line is connected to the second output circuit in the odd-numbered signal transmission part; and
the first clock line is connected to the first output circuit in an even-numbered signal transmission part, and the third clock line is connected to the second output circuit in the even-numbered transmission part.

4. The gate driver of claim 1, wherein the first output circuit is configured to output the (n)th carry signal to the second output circuit and to a subsequent signal transmission part.

5. The gate driver of claim 1, wherein the first output circuit and the second output circuit are implemented as a same circuit.

6. The gate driver of claim 1, wherein:
the first output circuit includes a first-a transistor, a second-a transistor, a third-a transistor, a fourth-a transistor, a fifth-a transistor, a sixth-a transistor, and a seventh-a transistor;
the first-a transistor includes a gate electrode to which a second clock signal is applied, a first electrode connected to a first-a node, and a second electrode connected to a second-a node;
the second-a transistor includes a gate electrode to which the start pulse or a preceding carry signal is applied, a first electrode connected to a third-a node, and a second electrode connected to a first-a power line;
the third-a transistor includes a gate electrode connected to the third-a node, a first electrode connected to a fourth-a node, a second electrode connected to the first-second control node;
the fourth-a transistor includes a gate electrode connected to the second-a node, a first electrode connected to the first-second control node, and a second electrode connected to the first-a power line;
the fifth-a transistor includes a gate electrode connected to a second-a power line to which a low potential voltage is applied, a first electrode connected to the second-a node, and a second electrode connected to the first-first control node;
the sixth-a transistor includes a gate electrode connected to the first-first control node, a first electrode connected to the second-a power line, and a second electrode connected to a first output node; and
the seventh-a transistor includes a gate electrode connected to the first-second control node, a first electrode connected to the first output node, and a second electrode connected to the first-a power line.

7. The gate driver of claim 6, further comprising:
a first-a capacitor connected between the third-a node and the fourth-a node;
a second-a capacitor connected between the first-second control node and the first-a power line; and
a third-a capacitor connected between a gate electrode and a second electrode of the sixth-a transistor.

8. The gate driver of claim 6, wherein:
the second output circuit includes a first-b transistor, a second-b transistor, a third-b transistor, a fourth-b transistor, a fifth-b transistor, a sixth-b transistor, and a seventh-b transistor;
the first-b transistor includes a gate electrode connected to a fourth-b node to which a first clock signal or a fourth clock signal is applied, a first electrode connected to a first-b node, and a second electrode connected to a second-b node;
the second-b transistor includes a gate electrode to which the (n)th carry signal is applied, a first electrode connected to a third-b node, and a second electrode connected to a first-b power line;
the third-b transistor includes a gate electrode connected to the third-b node, a first electrode connected to the fourth-b node, a second electrode connected to a second-second control node;
the fourth-b transistor includes a gate electrode connected to a second-b node, a first electrode connected to the second-second control node, and a second electrode connected to the first-b power line;
the fifth-b transistor includes a gate electrode connected to a second-b power line to which a low potential voltage is applied, a first electrode connected to the second-b node, and a second electrode connected to the second-first control node;
the sixth-b transistor includes a gate electrode connected to the second-first control node, a first electrode connected to the second-b power line, and a second electrode connected to a second output node; and
the seventh-b transistor includes a gate electrode connected to the second-second control node, a first electrode connected to the second output node, and a second electrode connected to the first-b power line.

9. The gate driver of claim 8, further comprising:
a first-b capacitor connected between the third-b node and the fourth-b node;
a second-b capacitor connected between the second-second control node and the first-b power line; and
a third-b capacitor connected between a gate electrode and a second electrode of the sixth-b transistor.

10. The gate driver of claim 1, wherein:
the first output circuit includes a first-a transistor, a second-a transistor, a third-a transistor, a fourth-a transistor, a fifth-a transistor, a sixth-a transistor, a seventh-a transistor, and an eighth-a transistor;
the first-a transistor includes a gate electrode to which a first carry clock signal is applied, a first electrode to which the start pulse is applied, and a second electrode connected to a second-a node;
the second-a transistor includes a gate electrode connected to a second carry clock signal, a first electrode connected to the second-a node, and a second electrode connected to a third-a node;
the third-a transistor includes a gate electrode connected to the first-second control node, a first electrode connected to the third-a node, and a second electrode connected to a first-a power line;
the fourth-a transistor includes a gate electrode to which the first carry clock signal is applied, a first electrode connected to a second-a power line to which a low potential voltage is applied, and a second electrode connected to the first-second control node;
the fifth-a transistor includes a gate electrode connected to the second-a node, a first electrode connected to the first-a node, and a second electrode connected to the first-second control node;
the sixth-a transistor includes a gate electrode to which the low potential voltage is applied, a first electrode connected to the second-a node, and a second electrode connected to the first-first control node;
the seventh-a transistor includes a gate electrode connected to the first-first control node, a first electrode to which the second carry clock signal is applied, and a second electrode connected to a first output node; and
the eighth-a transistor includes a gate electrode connected to the first-second control node, a first electrode connected to the first output node, and a second electrode connected to the first-a power line.

11. The gate driver of claim 10, further comprising:
a first-a capacitor connected between the first-second control node and the first-a power line; and
a second-a capacitor connected between a gate electrode and a second electrode of the seventh-a transistor.

12. The gate driver of claim 10, wherein:
the second output circuit includes a first-b transistor, a second-b transistor, a third-b transistor, a fourth-b transistor, a fifth-b transistor, a sixth-b transistor, a seventh-b transistor, and an eighth-b transistor;
the first-b transistor includes a gate electrode to which a second gate clock signal is applied, a first electrode connected to a first-b node, and a second electrode connected to a second-b node;
the second-b transistor includes a gate electrode connected to a first gate clock signal, a first electrode connected to the second-b node, and a second electrode connected to a third-b node;
the third-b transistor includes a gate electrode connected to the second-second control node, a first electrode connected to the third-b node, and a second electrode connected to a first-b power line;
the fourth-b transistor includes a gate electrode to which the second gate clock signal is applied, a first electrode connected to a second-b power line to which a low potential voltage is applied, and a second electrode connected to the second-second control node;
the fifth-b transistor includes a gate electrode connected to the second-b node, a first electrode connected to a first-b node, and a second electrode connected to the second-second control node;
the sixth-b transistor includes a gate electrode to which the low potential voltage is applied, a first electrode connected to the second-b node, and a second electrode connected to the second-first control node;
the seventh-b transistor includes a gate electrode connected to the second-first control node, a first electrode to which the first gate clock signal is applied, and a second electrode connected to a second output node; and
the eighth-b transistor includes a gate electrode connected to the second-second control node, a first electrode connected to the second output node, and a second electrode connected to the first-b power line.

13. The gate driver of claim 12, further comprising:
a first-b capacitor connected between the second-second control node and the first-b power line; and
a second-b capacitor connected between a gate electrode and a second electrode of the seventh-b transistor.

14. A display device comprising:
a pixel array in which a number of data lines, a number of gate lines, and a number of pixel circuits are arranged;
a data driver configured to output a data voltage to the data lines; and
a gate driver configured to output a gate signal to the gate lines,
wherein the gate driver includes a plurality of signal transmission parts that are connected in a cascade configuration via carry lines through which carry signals is applied from preceding signal transmission parts and that are configured to output gate signals according to a clock signal, and
wherein an (n)th signal transmission part includes:
a first output circuit configured to receive a start pulse or an (n-1)th carry signal from a preceding signal transmission part and the clock signal, and to charge or discharge a first-first control node and a first-second control node to output an (n)th carry signal, where n is a positive integer; and
a second output circuit configured to receive the (n)th carry signal output from the first output circuit and the clock signal, and to charge or discharge a second-first control node and a second-second control node to output an (n)th gate signal.

15. The display device of claim 14, wherein:
the clock signal includes a first clock signal applied via a first clock line and a second clock signal applied via a second clock line, the second clock signal having an opposite phase to the first clock signal;
the second clock line is connected to the first output circuit in an odd-numbered signal transmission part, and the first clock line is connected to the second output circuit in the odd-numbered signal transmission part; and
the first clock line is connected to the first output circuit in an even-numbered signal transmission part, and the second clock line is connected to the second output circuit in the even-numbered signal transmission part.

16. The display device of claim 14, wherein:
the clock signal includes a first clock signal applied via a first clock line, a second clock signal applied via a second clock line and having an opposite phase to the first clock signal, a third clock signal applied via a third clock line and having the same phase as the second clock signal, and a fourth clock signal applied via a fourth clock line and having the same phase as the first clock signal;
the second clock line is connected to the first output circuit in an odd-numbered signal transmission part, and the fourth clock line is connected to the second output circuit in the odd-numbered signal transmission part; and
the first clock line is connected to the first output circuit in an even-numbered signal transmission part, and the third clock line is connected to the second output circuit in the even-numbered transmission part.

17. The display device of claim 14, wherein the first output circuit is configured to output the (n)th carry signal to the second output circuit and to a subsequent signal transmission part.

18. The display device of claim 14, further comprising:
a timing controller configured to generate a clock signal having a first voltage level; and
a level shifter configured to generate a clock signal having a second voltage level based on the generated clock signal having the first voltage level and provide it to the gate driver,
wherein the timing controller is configured to modulate the clock signal having the first voltage level corresponding to an area to skip frames during frame skipping to provide the clock signal having the modulated first voltage level to the level shifter.

19. The display device of claim 14, further comprising:
a timing controller configured to generate a clock signal having a first voltage level;
a level shifter configured to generate a clock signal having a second voltage level based on the generated clock signal having the first voltage level and provide it to the gate driver; and
a switch connected to a line through which the clock signal having the first voltage level is input from the level shifter,
wherein the switch is configured to receive a control signal from the timing controller and to modulate the clock signal having the first voltage level by switching on or off based on the control signal.

20. The display device of claim 14, further comprising:
a timing controller configured to generate a clock signal having a first voltage level;
a level shifter configured to generate a clock signal having a second voltage level based on the generated clock signal having the first voltage level and provide it to the gate driver; and
a switch connected to a line through which the clock signal having the second voltage level is output from the level shifter,
wherein the switch is configured to receive a control signal from the timing controller and to modulate the clock signal having the second voltage level by switching on or off based on the control signal.
